(19) United States
(12) Patent Application Publication
(10) Pub. No.: US 2016/0358383 A1
(43) Pub. Date: Dec. 8, 2016

(54) SYSTEMS AND METHODS FOR AUGMENTED REALITY-BASED REMOTE COLLABORATION

(71) Applicants: Steffen Gauglitz, Falmouth, MA (US); Benjamin Nuernberger, Santa Barbara, CA (US); Matthew Alan Turk, Santa Barbara, CA (US); Tobias Höllerer, Santa Barbara, CA (US)

(72) Inventors: Steffen Gauglitz, Falmouth, MA (US); Benjamin Nuernberger, Santa Barbara, CA (US); Matthew Alan Turk, Santa Barbara, CA (US); Tobias Höllerer, Santa Barbara, CA (US)

(21) Appl. No.: 15/173,276

(22) Filed: Jun. 3, 2016

Related U.S. Application Data
(60) Provisional application No. 62/171,755, filed on Jun. 5, 2015.

(51) Int. Cl. G06T 19/00; G06K 9/00; H04N 7/15; G06T 15/20; G06T 7/20; G06T 11/60; G09G 5/00; G06T 7/00

(52) U.S. Cl. CPC G06T 19/006; G09G 5/003; G06K 9/00711; G06T 7/004; G06T 19/003; G06T 15/20; G06T 7/20; G06K 9/00335; G06T 11/60; H04N 7/157; G06T 2200/04

(57) ABSTRACT

Various embodiments each include at least one of systems, methods, devices, and software for an augmented shared visual space for live mobile remote collaboration on physical tasks. One or more participants in location A can explore a scene in location B independently of one or more local participants current camera position in location B, and can communicate via spatial annotations that are immediately visible to all other participants in augmented reality.

### RELATED APPLICATION AND PRIORITY CLAIM

This application is related and claims priority to U.S. Provisional Application No. 62/171,755, filed on Jun. 5, 2015 and entitled “SYSTEMS AND METHODS FOR AUGMENTED REALITY-BASED REMOTE COLLABORATION,” the entirety of which is incorporated herein by reference.

### STATEMENT OF GOVERNMENT SPONSORED SUPPORT

The subject matter here was developed with support under Grant (or Contract) No. U.S. Pat. No. 1,219,261, entitled “Telecollaboration in Physical Spaces,” awarded by the National Science Foundation. The subject matter here was also developed with support under Grant (or Contract) No. CAREER IIS-0747520, entitled “Anywhere Augmentation: Practical Mobile Augmented Reality in Unprepared Physical Environments,” also awarded by the National Science Foundation. The subject matter here was also developed with support under Grant (or Contract) No. N00014-14-1-0133 awarded by the Office of Naval Research. These entities may have certain rights to the subject matter herein.

### BACKGROUND INFORMATION

Current mobile communication technologies allow remote communication partners to communicate verbally, by sharing live video of their environments, or by sharing digital data. Partially because current technology does not enable many natural forms of communication and interaction, current audio teleconferences or videoconferences can be cumbersome and ineffective in many situations. What is needed in the art is a mobile communication technology solution that allows a communication partner to refer to the remote physical environment using a means other than verbal description.

In the following detailed description of systems and methods for augmented reality-based remote collaboration, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be used and that structural, logical, and electrical changes may be made without departing from the scope of the inventive subject matter. Such embodiments of the inventive subject matter may be referred to, individually and/or collectively, herein by the term “invention” or “subject matter” merely for convenience and without intending to limit the scope of this application voluntarily to any single invention or inventive concept if more than one is in fact disclosed. The following description is, therefore, not to be taken in a limited sense, and the scope of the inventive subject matter is defined by the appended claims.

### BRIEF DESCRIPTION OF THE DRAWINGS

FIG. 1 shows an example live Augmented Reality-based remote collaboration system, according to an embodiment.

FIG. 2 shows an overview of the system architecture, according to an embodiment.

FIG. 3 shows a screenshot of the remote user's interface, according to an embodiment.

FIG. 4 depicts one example of a user study task, according to an embodiment.

FIG. 5 shows a histogram of task times per interface, according to an embodiment.

FIG. 6 shows results from interface ratings intermediate questionnaires, according to an embodiment.

FIG. 7 shows results from individual features intermediate questionnaires, according to an embodiment.

FIG. 8 shows results from interface preference post-study questionnaire, according to an embodiment.

FIG. 9 shows augmented reality annotations and virtual scene navigation, according to an embodiment.

FIG. 10 shows an overview of the collaborative system, according to an embodiment.

FIG. 11 shows a screenshot of the remote user's touchscreen interface, according to an embodiment.

FIG. 12 shows depth interpretations of 2D drawings, according to an embodiment.

FIG. 13 shows user preference among the four different depth interpretations, according to an embodiment.

FIG. 14 shows ratings of two visualization options, according to an embodiment.

FIG. 15 shows various navigation features, according to an embodiment.

FIG. 16 shows a software stack for processing events from pointing devices, according to an embodiment.

FIG. 17 shows a method of zooming in, according to an embodiment.

FIG. 18 shows a screenshot during an orbit operation, according to an embodiment.

FIG. 19 shows ratings of various navigation elements, according to an embodiment.

FIG. 20 is a block diagram of a computing device, according to an embodiment.

### DETAILED DESCRIPTION

To address the limitations of current mobile communication technologies, the present subject matter augments remote interactions, thereby providing an improved remote interaction paradigm. As described herein, this Augmented Reality (AR) solution contains a conceptual framework, a system design and implementation, and several interface elements for the remote interaction paradigm.

This AR solution enables collaboration between two collaborators in different physical locations. As described herein, a first collaborator is described as being located in physical location A, and may be referred to as a “local user” or “local collaborator.” Similarly, a second collaborator is described as being located in physical location B, and may be referred to as a “remote user” or “remote collaborator.” This AR solution enables the remote collaborator to control his or her viewpoint of physical location A, such as by adjusting camera controls or other viewpoint adjustments. This AR solution enables the remote collaborator to communicate information with visual or spatial reference to physical objects in physical location A, where the information is sent from the remote collaborator to the collaborator in this physical location A. The visual and/or spatial reference information may include identifying objects, locations, directions, or spatial instructions by creating annotations, where the annotations are transmitted to the collaborator in physical location A and visualized using appropriate display technology. For example, the AR solution may include a visual display for the collaborator in physical location A, where the annotations are overlaid onto and anchored to the respective real world object or location.

The system architecture of this AR solution includes several important components that enable various communication elements and remote user interface elements to make this interaction intuitive and efficient.

Using the technology described herein, a wide array of situations in which remote collaborators collaborate on a “physical” situation (that is, a situation in which physical artifacts are concerned and need to be referred to) could be solved much more efficiently than with today's (verbal or verbal and video) communication tools. Existing commercial systems for “telestration” do not offer the flexibility and level of interaction outlined here. Applications include in particular: repair of any kind of system or machine (by technicians and/or laymen) with the help of a remote specialist, any kind of situation requiring advice of a remote person on a particular situation, and remote assessment of the value, damage to, or otherwise pertinent state of an object of interest.

The system described in this invention is capable of running on standard, off-the-shelf hardware such as current smartphones or tablets, requires no instrumentation or other preparation of the environment with few constraints, and requires minimal training; it is thus highly accessible to a large audience.

The functions or algorithms described herein may be implemented in hardware, software, or a combination of software and hardware. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, a mobile device, server, a router, or other device capable of processing data including network interconnection devices. Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

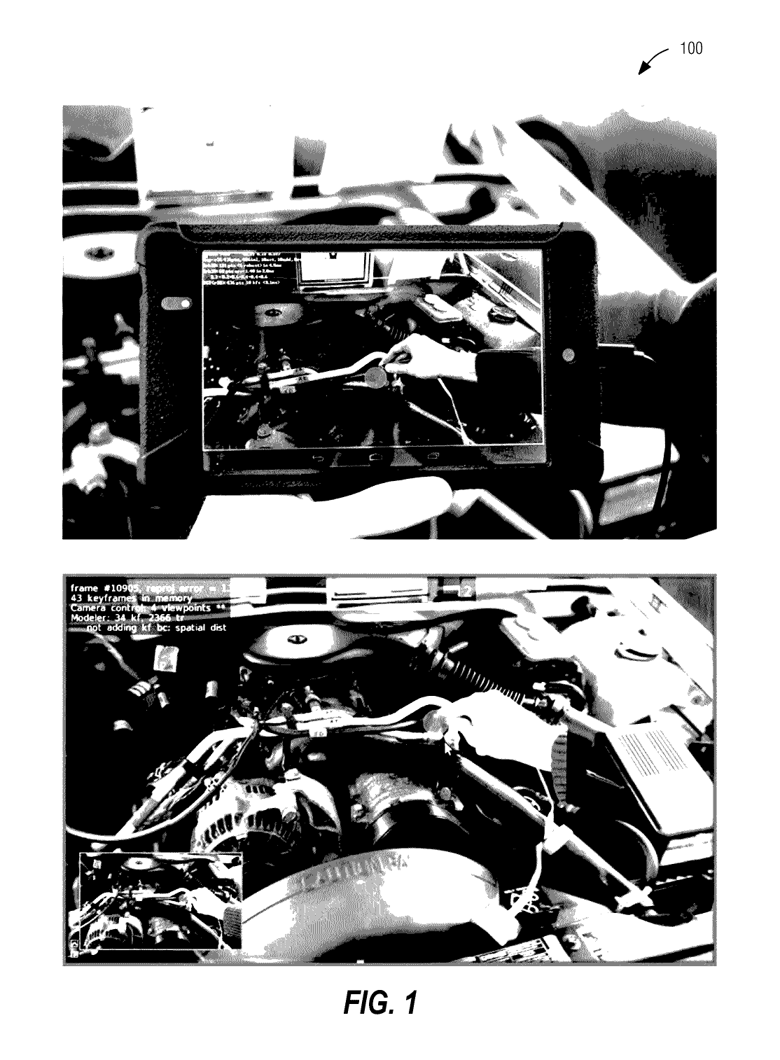

FIG. 1 shows an example live Augmented Reality-based remote collaboration system 100, according to an embodiment. FIG. 1 shows the user in physical location A in front of a car engine, identifying a particular element, which the user in physical location B has marked with the yellow dot. FIG. 1 also shows the view of the user in physical location B onto the scene in physical location A, which (at this moment) shows more context than the view on the screen of the user in physical location A. The latter is shown as an inset on the bottom left as well as being projected onto the model. The user in physical location B can browse this environment independently of the current pose of the image capture device in physical location A, and can set annotations, which are immediately visible to the user in physical location A in AR.

In this patent application, we present a system that supports an augmented shared visual space for live mobile remote collaboration on physical tasks. The user in physical location B can explore the scene independently of the current pose of the image capture device in physical location A and can communicate via spatial annotations that are immediately visible to user in in physical location A in AR. This system operates on off-the-shelf hardware and uses real-time visual tracking and modeling, thus not requiring any preparation or instrumentation of the environment. It creates a synergy between video conferencing and remote scene exploration under a unique coherent interface. To evaluate the collaboration with the system, we conducted an extensive outdoor user study with 60 participants comparing the system with two baseline interfaces. The results indicate an overwhelming user preference (80%) for the system, a high level of usability, as well as performance benefits compared with one of the two baselines.

In recent years, the use of video conferencing has become ubiquitous. However, with current technology, users are limited to passively watching disjoint video feeds, which provide no means for interaction with the remote physical environment. As effective collaboration often involves sharing, exploring, referencing, or even manipulating the physical environment, tools for remote collaboration should provide support for these interactions. Researchers have explored various means to do so; however, two of the most common limitations in existing work are that the remote user's view onto the scene is constrained to the typically small field of view of the local user's camera, and that any support for spatially referencing the scene is contingent upon a stationary camera.

In this work, we leverage computer vision and the paradigm of AR to facilitate more immersive interaction with the remote environment in general, and to address the aforementioned limitations in particular. This application describes a fully functional system for mobile remote collaboration, running on off-the-shelf hardware, in which a remote user can (a) control a virtual camera and thus explore the live scene independently of the local user's current camera position, and (b) communicate via spatial annotations that are immediately visible to the local user, or users, in AR (cf. FIG. 1). This system does not require any preparation or instrumentation of the environment. Instead, the physical scene is tracked and modeled incrementally in real time and in 3D, using, for example, monocular vision-based simultaneous localization and mapping (SLAM) and subsequent surface modeling. The emerging model then supports anchoring of annotations, virtual navigation, and synthesis of novel views.

This application further presents an extensive outdoor user study with 60 participants (30 teams) comparing the system with two baselines. Both user ratings and task performance are discussed in detail. This study is among the first user studies overall to rely purely on visual SLAM technology as an enabling technology (rather than as the subject of interest) in an outdoor environment.

Research on remote collaboration and telepresence is multifaceted; for example, some systems focus on creating fully immersive, three-dimensional telepresence experiences with increasingly lower instrumentation barriers.

Support for spatial references to the remote scene in video-mediated collaboration or telepresence has been an active research topic. Notable early works include “VideoDraw” and the “DoubleDigitalDesk.” Modalities that have been investigated include remote pointers, drawing onto a live video stream, and transferring videos of hand gestures. These annotations are then displayed to the collaborator on a separate screen in a third-person perspective, on a head-worn display, or via projectors.

However, in order to support spatially referencing physical objects, all of these systems either assume a stationary camera (at least during the relevant interaction), since otherwise the virtual annotations lose their referents, or require extensive equipment and prepared environments to track and thus maintain the locations of the annotations. Further, the remote user's view onto the physical scene is either restricted to a stationary camera or tightly coupled to the local user's head or body movement, thus forcing the remote user to constantly re-orient and ask the local user to hold still (or, in the case of some examples, enforcing this by freezing both users' views) when referencing an object. One alternative is to use a robot, which can be controlled by the remote user; however, this requires specialized hardware and limits the range of operation.

The present subject matters leverages computer vision-based tracking and modeling and the paradigm of collaborative AR to support world-stabilized annotations and virtual camera movements. This system operates in environments of arbitrary geometric complexity (which has implications for almost all components of the system), and provides a feature-rich virtual navigation that allows the remote users to explore the environment independently of the local users' current camera positions. Further, the system consists of stand-alone off-the-shelf hardware entities that communicate via wireless network.

Some examples use a customized setup with a mobile device and two active depth sensors mounted onto a monopod which gives the ability to reconstruct the environment (on the local user's side) and to reconstruct and transfer hand gestures (from the remote user's side) in 3D. In contrast, the system needs only an off-the-shelf tablet. Another difference worth noting is the method of scene navigation by the remote user: the remote user is equipped with a mobile device and uses the device's physical movement to navigate the remote (virtual) environment, while we use virtual navigation.

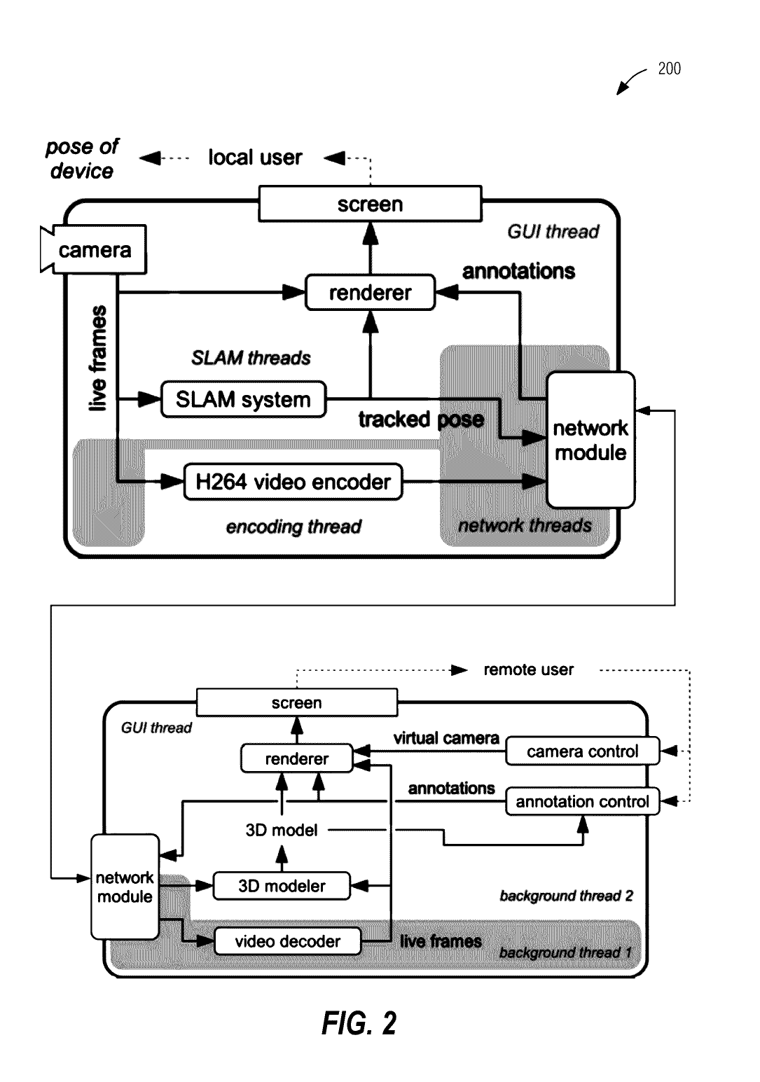

FIG. 2 shows an overview of the system architecture 200, according to an embodiment. System architecture 200 shows both the local user's system on top and the remote user's system on bottom. In an example, the local user's system may be running on an Android-based lightweight tablet or smartphone, and the remote user's system may be running on a commodity PC with Ubuntu. Since device hardware (camera and display), network communication, real-time processing, and background tasks are involved, both systems employ a host of components and threads.

The local user's interface, running on a lightweight tablet, is intentionally simple. From the user's perspective, it behaves exactly like a live video of the user's own view plus AR annotations, i.e., a classic magic lens. (The local user's view is not affected by remote user's camera control.) The only control the user exerts during its operation is by manipulating the position and orientation of the device. The system could equally be used with other AR displays such as a head-worn or projective display.

Under the hood, the system runs a SLAM system and sends the tracked camera pose along with the encoded live video stream to the remote system. The local user's system receives information about annotations from the remote system and uses this information together with the live video to render the augmented view.

The system is implemented as an Android app, running on several state-of-the-art Android devices. For the user study, we used a Google Nexus 7 2013, a 7″ tablet powered by a Qualcomm Snapdragon S4 Pro with 1500 MHz Krait quad core CPU. The core SLAM implementation, including access to the live camera frames and support for rendering for them, has been provided to us by Qualcomm. Communication with the SLAM system, handling of the raw image data, and rendering are implemented in C/C++, while higher-level app structure, user interface, and network communication are implemented in Java, with data exchange between the two layers via JNI. The live frames are encoded as a H.264 video stream. A minimal HTTP server streams the data (encoded video, tracked camera pose, and other meta-data) upon request from a remote connection, and manages remote requests for insertion/deletion of annotations (encoded as HTTP requests).

The system operates at 30 frames per second. System latencies were measured using a camera with 1000 fps, which observed a change in the physical world (a falling object passing a certain height) as well as its image on the respective screen. The latency between physical effect and the local user's tablet display—including image formation on the sensor, retrieval, processing by the SLAM system, rendering of the image, and display on the screen—was measured as 205±22.6 ms.

The remote user's interface, running on a commodity PC (without high-end GPUs or such), starts as a live video stream, but is augmented by two controls, the camera control and annotation control.

The system consists of five main modules—network module, 3D modeler, camera control, annotation control, renderer—and the framework to hold them together. Due to this modular framework, different implementations for each module can be readily swapped in and out upon the start of the program via command line arguments. For example, for comparing the prototype against two baseline interfaces in the user study, we simply replaced the respective modules with simpler ones. In a similar fashion, we also implemented modules that load virtual 3D models (instead of modeling from live video) and allow for other types of camera control.

The latency between physical effect and the remote user's display including image formation on the local user's sensor, retrieval, processing by the SLAM system, video encoding, transmission via wireless network, video decoding, rendering, and display—was measured as 251±22.2 ms; i.e., less than 50 ms between the local and the remote user's display.

The network module receives the data stream from the local user's device, sends the incoming video data on to the decoder, and finally notifies the main module when a new frame (decoded image data+meta-data) is available.

A 3D surface model is constructed on the fly from the live video stream and from associated camera poses. Keyframes were selected based on a set of heuristics (good tracking quality, low device movement, minimum time interval & translational distance between keyframes), then detect and describe features in the new frame using SIFT. Four closest existing keyframes were chosen and matched against their features (one frame at a time) via an approximate nearest neighbor algorithm and collect matches that satisfy the epipolar constraint (which is known due to the received camera poses) within some tolerance as tentative 3D points. If a feature has previously been matched to features from other frames, we check for mutual epipolar consistency of all observations and merge them into a single 3D point if possible; otherwise, the two 3D points remain as competing hypotheses.

Next, all tentative 3D points are sorted by the number of supporting observations and are accepted one by one unless one of their observations has been previously “claimed” by an already accepted 3D point (which, by construction, had more support). At least four observations were required for a point to be accepted, and we further remove a fraction of points with the largest 3D distances to their two nearest neighbors. The algorithm is thus robust to even large fractions of mismatches from the stereo matching stage.

Several steps are required to obtain a surface model from the 3D point cloud. First, a Delaunay tetrahedralization of the point cloud is created. Each tetrahedron is then labeled as “free” or “occupied,” and the interface between free and occupied tetrahedra is extracted as the scene's surface. The labeling of the tetrahedra works as follows: A graph structure is created in which each tetrahedron is represented by a node, and nodes of neighboring tetrahedra are linked by edges. Each node is further linked to a “free” (sink) node and an “occupied” (source) node. The weights of all edges depend on the observations that formed each vertex; for example, an observation ray that cuts through a cell indicates that this cell is free, while a ray ending in front of a cell indicates that the cell is occupied. Finally, the labels for all tetrahedra are determined by solving a dynamic graph cut problem. This modeling is refined further by taking the orientation of observation rays to cell interfaces into account, which reduces the number of “weak” links and thus the risk that the graph cut finds a minimum that does not correspond to a true surface.

Table 1 below shows average timings of the 3D modeler to process and integrate one new keyframe into the model, running on a single core of a 3 GHz Intel i7 CPU with 4 GB RAM. All times are given in milliseconds, with associated standard deviations. Incorporating all logs from the user study to be discussed below, the data in the three columns are based on 300, 429, and 481 keyframe integrations, respectively.

| # of keyframes in model | 1-10 | 11-25 | >25 |
|---|---|---|---|
| Keypoint detection | 32 ± 2 | 32 ± 3 | 34 ± 2 |
| Keypoint description | 904 ± 124 | 868 ± 144 | 795 ± 167 |
| Stereo matching | 121 ± 59 | 166 ± 38 | 153 ± 45 |
| Merging & filtering of vertices | <1 ± 1 | 5 ± 1 | 9 ± 2 |
| Updating tetrahedralization | <1 ± 1 | 2 ± 2 | 3 ± 3 |
| Calculating graph costs | 10 ± 6 | 51 ± 14 | 128 ± 28 |
| Solving graph cut | <1 ± <1 | 1 ± <1 | 1 ± 1 |
| Extracting & smoothing | 4 ± 8 | 9 ± 21 | 21 ± 9 |
| surface | | | |
| Total time | 1082 ± 140 | 1159 ± 175 | 1201 ± 208 |

Both updating the graph costs and solving the graph cut can be implemented in an incremental manner, with cost almost independent of the overall model size. As these steps were found to take up a negligible amount of time in the application (cf. Table 1), for simplicity we did not even implement the incremental algorithm. Nonetheless, the entire processing of a new keyframe and updating of the 3D surface model is completed within 1-1.5 seconds (cf. Table 1), which is easily fast enough, as it is smaller than the interval at which keyframes are added on average. Currently, the vast majority of the time is taken up by the keypoint description, which is independent of the model size. If necessary, the computation could be significantly sped up by using a more efficient descriptor implementation or algorithm and/or implementing the incremental graph update. Thus, the overall modeling algorithm is highly scalable to environments much larger than demonstrated here.

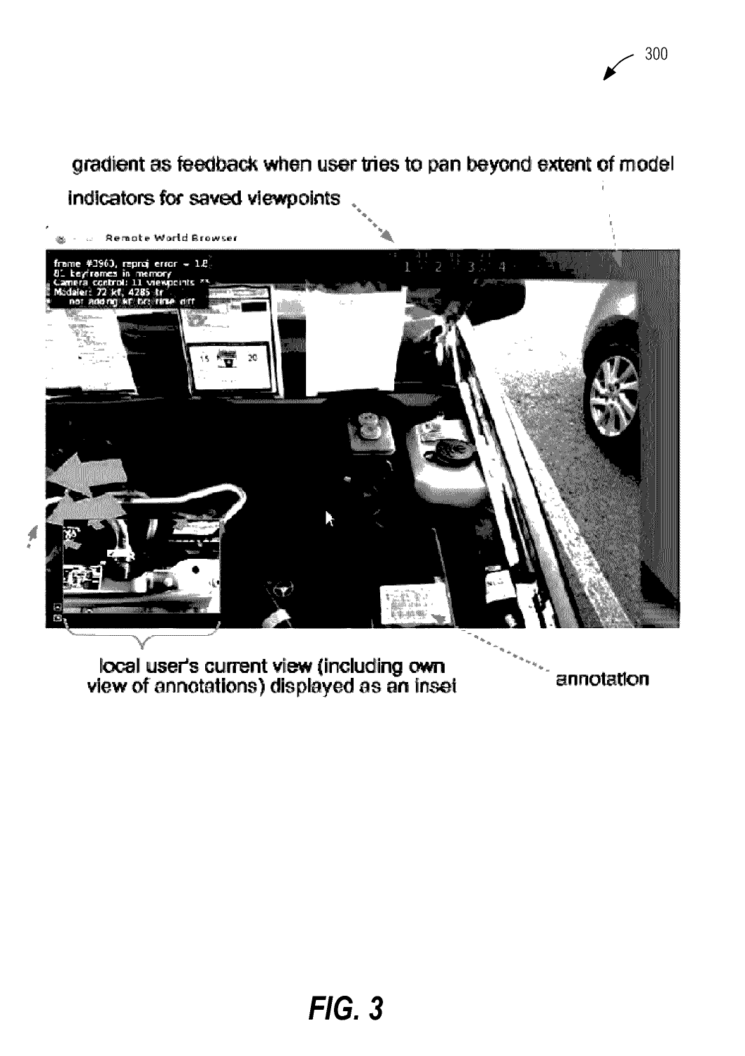

FIG. 3 shows a screenshot of the remote user's interface 300, according to an embodiment. Providing camera control (virtual navigation), or providing a remote user's ability to navigate the remote world via a virtual camera, independent of the local user's current location, is among the important contributions of this work. Some solutions use physical device movement for navigation. While this is arguably intuitive, using physical navigation has two disadvantages; one being generally true for physical navigation and the other one being specific to the application of live collaboration: First, the remote user needs to be able to physically move and track his/her movements in a space corresponding in size to the remote environment of interest, and “supernatural” movements or viewpoints (e.g., quickly covering large distances or adopting a bird's-eye view) are impossible. Second, it does not allow coupling of the remote user's view to the local user's view (and thus have the local user control the viewpoint) without breaking the frame of reference in which the remote user navigates. This application describes some embodiments using virtual navigation, and it is important that the navigation gives the remote user the option of coupling his/her view to that of the local user. The systems and methods described herein may also be applied to physical navigation.

Within virtual navigation, we decided to use a keyframe-based navigation as explained in the following for several reasons: first, mapping unconstrained 3D navigation to 2D controls requires relatively complex interfaces; second, the model is inherently constrained by what has been observed by the local user's camera, and a keyframe-based approach offers a natural way to constrain the navigation accordingly; third, a keyframe-based approach allows for image-based rendering with high levels of fidelity. Therefore, the camera control module continually stores new keyframes with their associated camera poses from the live video stream if the tracking quality is good enough. These keyframes are independent of the ones used by the modeler; they serve a different purpose and are maintained separately. Keyframes that have become obsolete because they are close to a newer keyframe are automatically discarded.

The individual controls were designed to be as intuitive as possible and resemble controls familiar from other exploration tools such as Google Street View and Photo tourism. Viewpoint transitions are implemented by smoothly interpolating between the camera poses and are rendered as visually seamlessly as possible.

The present subject matter provides the ability to freeze and return to live views. The application starts with the remote view coupled to the local user's live view. With a single right-click, the remote user “freezes” his/her camera at the current pose, for example in order to set annotations precisely, or as a starting point for further navigation. Whenever the remote user's view is not coupled to the local user's view, the latter is displayed to the remote user as an inset (cf. FIG. 3). A click onto this inset or pressing 0 immediately transitions back to the live view.

The present subject matter provides panning and zooming capabilities. By moving the mouse while its right button is pressed, the user can pan the view in a panorama-like fashion (rotate around the current camera position). To prevent the user from getting lost in unmapped areas, we constrain the panning to the angular extent of the modeled environment. To ensure that the system does not appear unresponsive to the user's input while enforcing this constraint, we allow a certain amount of “overshoot” beyond the allowed extent. In this range, further mouse movement away from the modeled environment causes an exponentially declining increase in rotation and visual feedback in the form of an increasingly intense blue gradient along the respective screen border (FIG. 3). Once the mouse button is released, the panning quickly snaps back to the allowed range. Thus, the movement appears to be constrained by a (nonlinear) spring rather a hard wall.

The user can also zoom into and out of the view with the scroll wheel. Zooming is implemented as a change of the virtual camera's field of view (rather than dollying) to avoid having to deal with corrections for parallax or occlusions from objects behind the original camera position.

The present subject matter provides click to change viewpoint capabilities. When the user right-clicks into the view, we compute the 3D hit point, and subsequently find the camera whose optical axis is closest to this point (which may be the current camera as well). This camera is transitioned and yaw and pitch adapted such that the new view centers on the clicked-upon point. This allows the user to quickly center on a nearby point as well as quickly travel to a faraway point with a single click.

The present subject matter provides the ability to save and revisit viewpoints. Further, the user can actively save a particular viewpoint to revisit it later. Pressing Alt plus any number key saves the current viewpoint; pressing the respective number key alone revisits this view later. Small numbers along the top of the screen indicate which numbers are currently in use (see FIG. 3).

This keyframe-based navigation is simple and intuitive and allows for flexible exploration of a scene. However, there are situations in which it is limited: it does not allow navigation to a never-visited viewpoint, or control over each degree of freedom individually, as may be desired by advanced users for fine-grained maneuvering.

In addition to being able to control the viewpoint, the remote user can set and remove virtual annotations. Annotations are saved in 3D world coordinates, are shared with the local user's mobile device via the network, and immediately appear in all views of the world correctly anchored to their 3D world position (cf. FIGS. 1 and 3).

For this prototype, we implemented only simple, animated spherical markers. If annotations are outside the user's current field of view, an arrow appears along the border of the screen pointing towards the annotation (see FIG. 3). Annotations are “pulsing” with 1 Hz and 15% amplitude to increase their visual saliency. Together with the independent viewpoint control as described above, the remote user can thus effectively direct the local user to elements outside the local user's current field of view.

The remote user sets a marker by simply left-clicking into the view (irrespective if “live” or “decoupled”). The depth of the marker is derived from the 3D model, presuming that the user wants to mark things on physical surfaces rather than in mid-air. Pressing the space bar removes all annotations. More complex and/or automatic erasure management could be integrated as desired.

These annotations were sufficient for the task (cf. user study tasks below), but other tasks may require annotations that are more complex. More complex annotations like this could be integrated (now world-stabilized as well) as needed.

The renderer renders the scene using the 3D model, the continually updated keyframes, the incoming live camera frame (including live camera pose), the virtual camera pose, and the annotations. In addition to a generally desirable high level of realism, a particular challenge rather unique to the application is the seamless transition to and from the live video. That is, as the virtual camera approaches the physical camera, the views should become identical, with no noticeable transition from “model view” to “live view.” This is achieved by using image-based rendering as follows.

The 3D model is rendered as a polygonal model, upon which the images of the live frame and closest keyframes are projected using projective texture mapping. As the virtual camera moves, the different textures are faded in and out by adapting their opacity. In areas, which are modeled accurately, transitions are thus seamless, with lighting effects naturally blending in. More sophisticated image-based rendering techniques could be integrated as appropriate.

The live view may extend beyond the area currently modeled in 3D. To ensure that these areas do not suddenly “disappear” immediately after transitioning away from the live view, we extend the model with a proxy plane (at the model's average distance to the camera) on which textures can be projected. To soften artifacts, we blur the parts of the projective textures that fall onto this part.

In effect, when the remote user's virtual camera pose is identical (coupled) to the local user's current physical camera pose, the rendered image is identical to the live video, and transitions to and away from it are seamless.

Due to the nature of the camera control, the camera is often at the location of a previously cached keyframe (albeit with possibly modified yaw, pitch, or field-of-view), which enables image-based rendering with high levels of fidelity. The 3D model is rarely visible as a polygonal model, thus modeling artifacts are rarely apparent. However, the more accurate the model, the better the transitions can be rendered, and the more precisely annotations can be anchored.

While the prototype delivers a robust, real-time AR experience, there are some assumptions and system limitations, such as level of detail of model, use of a static scene, stereo initialization, occlusion of annotations on local side, or one-way annotations. Regarding level of detail of model, building upon a tetrahedralization of a sparse point cloud, the modeling approach taken here is very fast (as demonstrated above), but results in a model that does not exhibit the level of detail as achievable, for example, with dense volumetric fusion. While the existence of the 3D model is relatively coarse level of detail is arguably acceptable, the keyframe-based navigation and rendering de-emphasize the modeling artifacts.

However, techniques to create a more detailed model exist, and since the system is modular—none of the other components depend on this particular modeling algorithm—other algorithms could be plugged in as needed. This includes algorithms to densify the point cloud while keeping the overall approach the same, using other, computationally more intensive, vision-based algorithms, or (where permissible by the application) active depth sensor-based modeling.

This system generally assumes that the scene is static. However, the SLAM system on the local user's side is quite robust to partial and/or gradual changes in the scene. Adapting the modeling, navigation and rendering is achievable via active detection and invalidation of changed regions.

Currently, the 3D model is available only on the remote user's side. Thus, annotations can be correctly occluded by the physical scene by the remote user's renderer, but not by the local user's renderer. While other depth cues (most notably, parallax) still indicate the annotation's location, it would be desirable to enable occlusion. The remote system can send either the model geometry or alternatively local visibility information per annotation back to the local device in order to enable occlusion on the local user's side.

This system currently limits creation of annotations to the remote user. The rationale is that the local user can spatially refer to the environment with his/her hands (as seen in FIG. 1)—it is the remote user who needs additional means. However, if deemed appropriate, it would also be straightforward to allow the local user to create annotations, for example by tapping onto his/her screen.

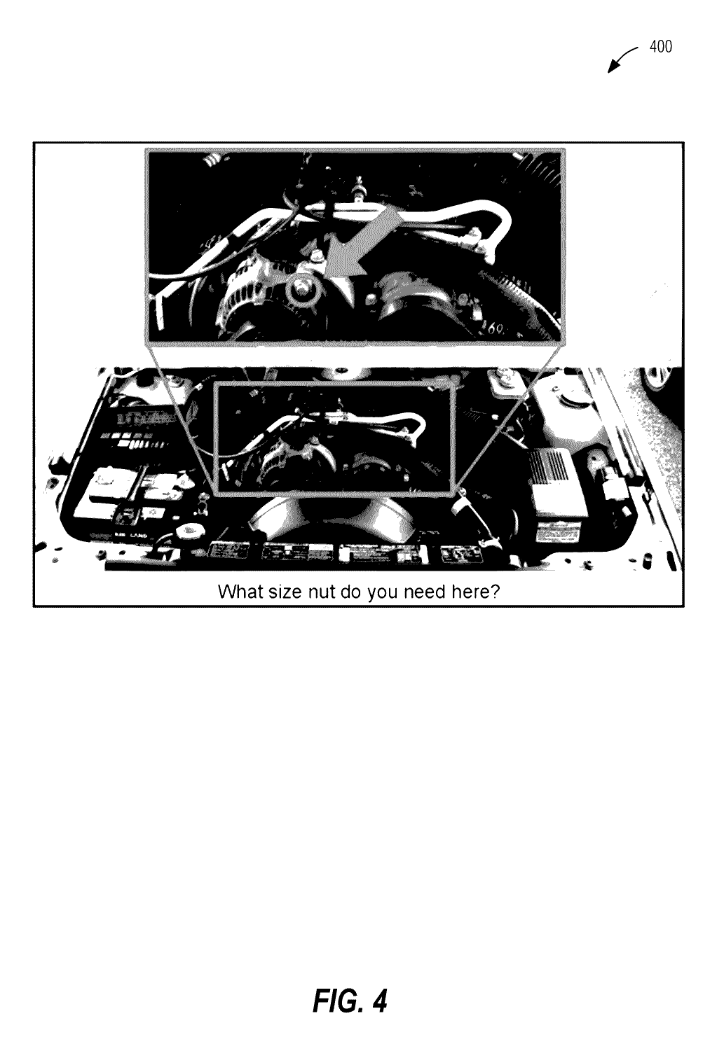

FIG. 4 depicts one example 400 of a user study task, according to an embodiment. The example 400 is out of 80 individual tasks. These instructions were provided to the remote user, who then needed to communicate the information to the local user.

To evaluate the system, we conducted a remote expert-local worker user study comparing the system with two baselines: a video and audio only interface and an interface with static annotations (also called “markers” throughout the study). Both the local and the remote users were study participants.

Several pilot study trials were conducted with a total of 20 users (10 teams), during which we refined study parameters, overall procedure, and training procedure.

A “car repair” task was chosen for the study. The local user stood in front of a car, hood open, and received help from the remote user in “identifying the problem.” The study took place outdoors, and while we used a relatively isolated location with no direct sunlight, several environment factors may be beyond control, including weather, light conditions, passers-by, and noise from a nearby street and a nearby airport. The study's external conditions were thus close to a real scenario. Network infrastructure and the remote user's PC were mounted onto a cart and positioned adjacent to the car such that the participants could communicate verbally, but not see each other.

To make sure that the individual tasks were roughly equivalent, quick enough to perform, independent of the individual user's dexterity, and not dangerous in any way, we used proxy tasks that would require similar communication between the users but little or no physical labor, such as locating individual elements and finding pieces of information. For example, instead of unscrewing a bolt, we asked the users to identify its size by testing it with a set of provided nuts, which requires the same communication between the users in order to identify the correct element but little physical labor. For each individual task, the remote user was given simulated expert knowledge in the form of a specific question (e.g., size of a particular screw or cable, rating of a particular fuse, serial number of a part) and a diagram indicating where the answer could be located (see FIG. 4). The remote user then had to communicate this information to the local user, who had to locate the requested information and write it down. In all conditions, the two users were able to talk to each other without restrictions.

Interface A: video only. The live video from the local user's camera is streamed to the remote user; the remote user does not have any means of interacting with the video or providing visual/spatial feedback. This is similar to using today's standard video conferencing tools.

Interface B: video+static markers. In addition to the features in condition A, the remote user can click into the video to create a marker visible to both users. However, the marker's position is stored in screen coordinates and thus moves with the camera rather than “sticking” to the world object. This condition is effectively similar to related works that assume a stationary camera.

Interface C is defined by the prototype as presented above. Conditions B and C both allowed up to five concurrent markers in different colors, with further clicks re-setting the oldest marker.

A within-subjects design was used with one independent variable (interface type) and one dependent variable (task completion time). The number of errors was recorded and several user ratings were obtained via questionnaires. The order of the interfaces was completely balanced, with each of the six possible orderings traversed by five of the 30 teams. For each team, three lists with 15 tasks were created at random, with the remaining tasks reserved for training.

Three hypotheses about the study's outcome were as follows:

H1: Users will complete the task faster with interface B and interface C than with interface A.

H2: Users will complete the task faster with interface C than with interface B.

H3: Users will prefer interface C over both interface A and interface B.

Participants included 60 users (18-30 years (mean 20.8), 29 female, 31 male) participated in the main study, working together in 30 teams (8 female/female, 7 female/male, 6 male/female, 9 male/male (local/remote user)). Each user received a compensation of USD 10; all teams additionally competed for a bonus of USD 10/20/40 per person for the top 5/second fastest/fastest error-free task performances for all three conditions combined.

In two teams not included in the numbers above, one user was colorblind. It remains unclear whether this affected the task performance. However, we used color extensively (markers, labels in the car, etc.), and at least one of the users was unable to disambiguate a few of the elements. The data from these two trials is not included in the analysis.

Each participant completed a colorblind test and a pre-study questionnaire with background information. The general setup and task were then explained in detail.

For each session, the study administrator explained the respective interface features in detail, and then the users conducted several training tasks with the respective interface. Each user completed a minimum of five training tasks for each new feature and was asked explicitly if they were comfortable using the interface before proceeding to the timed session. After each session, the users filled out an intermediate questionnaire rating this interface. Lastly, each user filled out a post-study questionnaire and received their compensation.

During the pilot study trials, it quickly became clear that not all of the camera control features that the prototype (interface C) featured were necessary for this particular environment and task, and that the limited amount of time prohibited explaining and training the user on each of them. The training is concentrated on a subset of features that appeared to be most useful in this context, namely, the freezing of the camera, and the saving/revisiting of viewpoints. However, the other features (panning, zooming, change viewpoint via click) were still available and were occasionally discovered and used by participants.

To ensure a consistently high quality of the required stereo initialization, the study administrator conducted the initialization step (until the modeler had started to extract 3D surface) before handing the device to the local user.

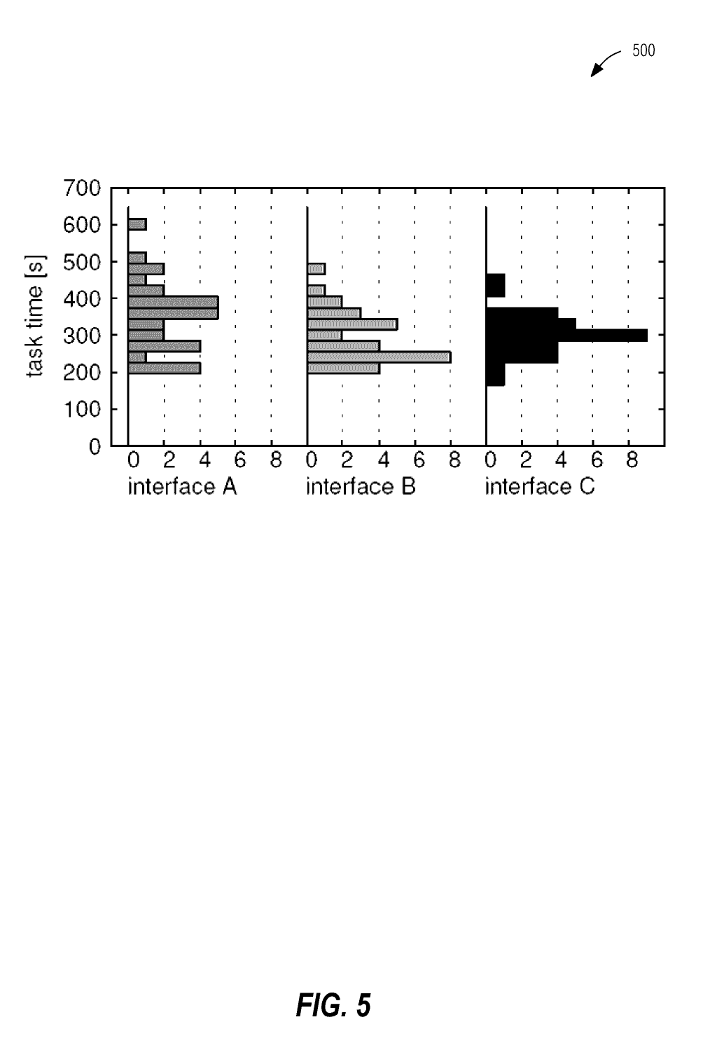

Overall, 98.5% of the tasks were answered correctly (21 errors at a total of 30×3×15 tasks). Analyzing the number of errors, Mauchly's test indicated that the assumption of sphericity against interface had not been violated (W(2)=0.95, p=0.50), and no significant effect of interface on the number of errors was found using a one-way repeated measures ANOVA (F(2,58)=0.47, p=0.63, and partial=0.016). Additionally, we note that 5 of the 21 errors were made on two particular subtasks in which the expert knowledge diagram may have been confusing. All users worked meticulously and thus that the comparison of the task times is meaningful, as shown in FIG. 5.

FIG. 5 shows a histogram of task times per interface 500, according to an embodiment. Analyzing the task times, Mauchly's test indicated that the assumption of sphericity had not been violated (W(2)=0.99, p=0.93). With a one-way repeated measures ANOVA, we found a significant effect of interface on task completion time with F(2,58)=6.94, p=0.0020, and η2partial=0.19. Post-hoc comparisons using Tukey's HSD test indicated that users were significantly faster with both interfaces B (M=313.6, SD=69.6) and C (M=317.5, SD=57.6) than with interface A (M=364.7, SD=96.7), thus supporting hypothesis H1. No significant difference was found between B and C; hence, hypothesis H2 was not supported.

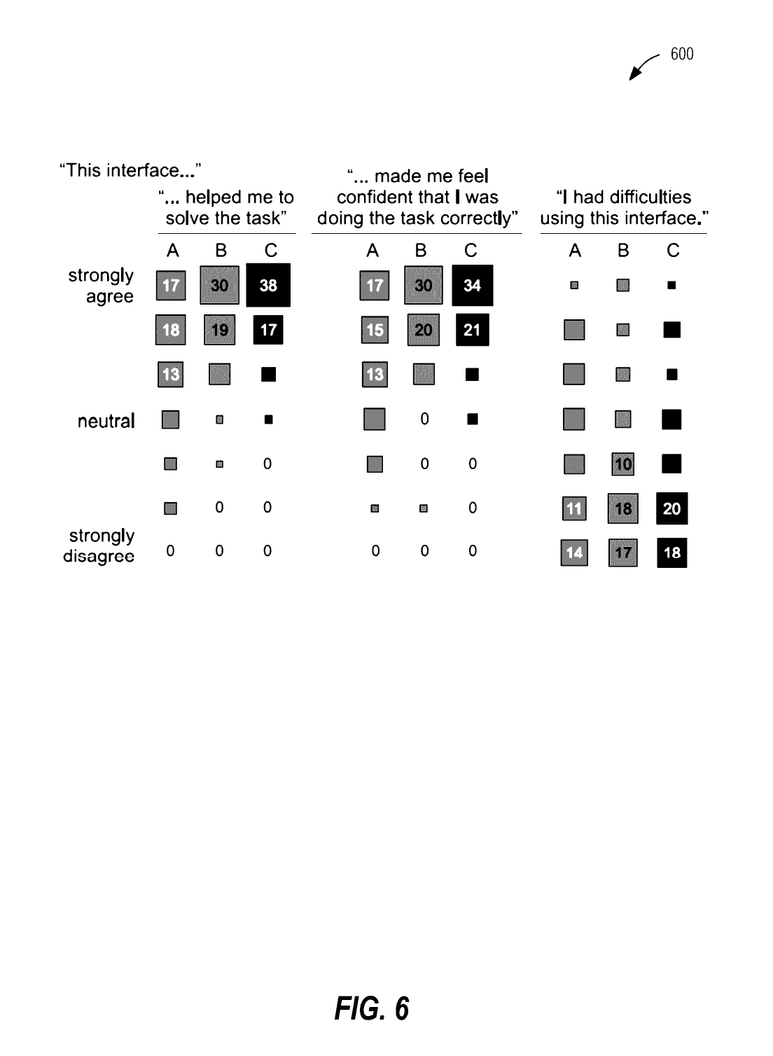

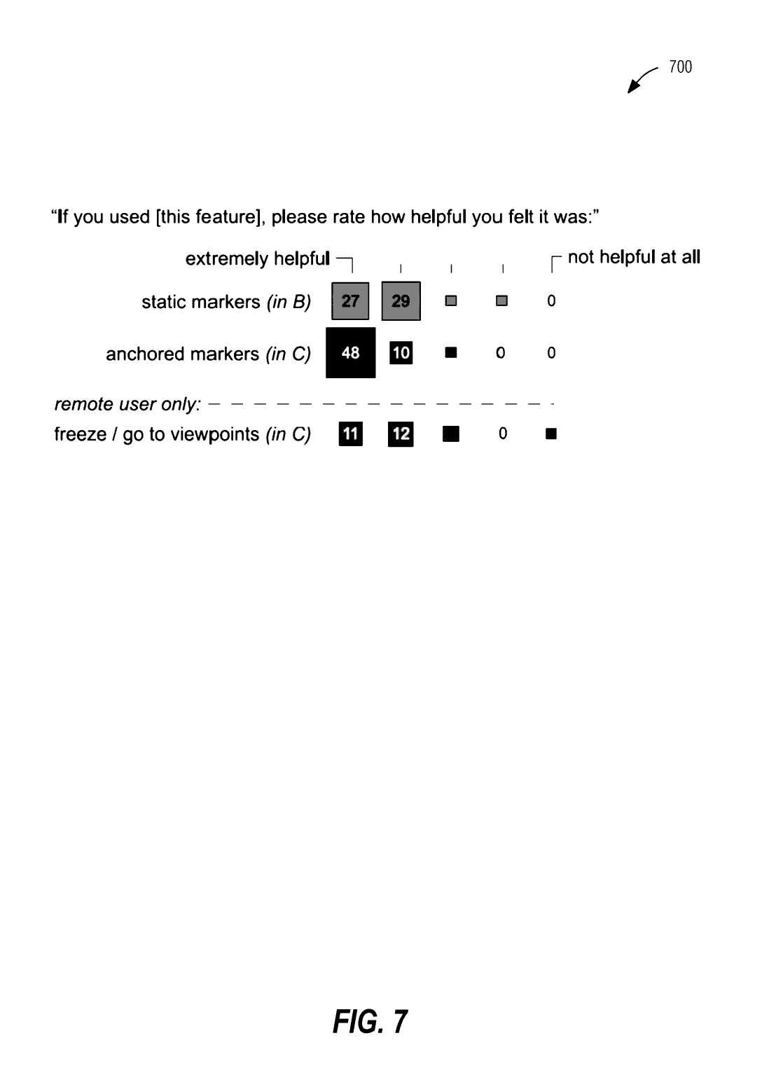

FIG. 6 shows results from interface ratings intermediate questionnaires 600, according to an embodiment. Similarly, FIG. 7 shows results from individual features intermediate questionnaires 700, according to an embodiment. In the intermediate questionnaires filled out immediately after each session (i.e., before the next interface was introduced), the users were asked to rate their level of agreement on a 7-point scale to the statements, “This interface helped me to solve the task,” “This interface made me feel confident that I was doing the task correctly,” and “I had difficulties using this interface.” The responses are aggregated in FIG. 6.

For these ratings, we decided to use a non-parametric test for the analysis to avoid the assumptions of interval data, normality, and sphericity.

According to Friedman's test, the ratings in response to the first two statements differ significantly among the interfaces (χ2 (2)=34.5, p<10-7, and χ2 (2)=37.8, p<10-7, respectively). Pairwise comparisons with Bonferroni's correction applied indicated that both B and C were rated better than A. For the third question (“I had difficulties . . . ”), Friedman's test also indicated a significant difference (χ2 (2)=8.1, p=0.017), but pairwise comparisons with Bonferroni's correction applied only revealed a possible borderline significant difference between A and C at p=0.019 (compared to the corrected threshold of 0.017).

Users were further asked to rate the helpfulness of individual features on a 5-point scale from “extremely helpful” to “not helpful at all” (FIG. 7). Wilcoxon's paired signed rank test (V=25, p<10-4) showed that the anchored markers (in interface C) were perceived as more helpful than the static markers (in interface B), with 80% of the users perceiving the former as “extremely helpful.” The camera control features were perceived as “extremely” or “very” helpful by 77% of the remote users.

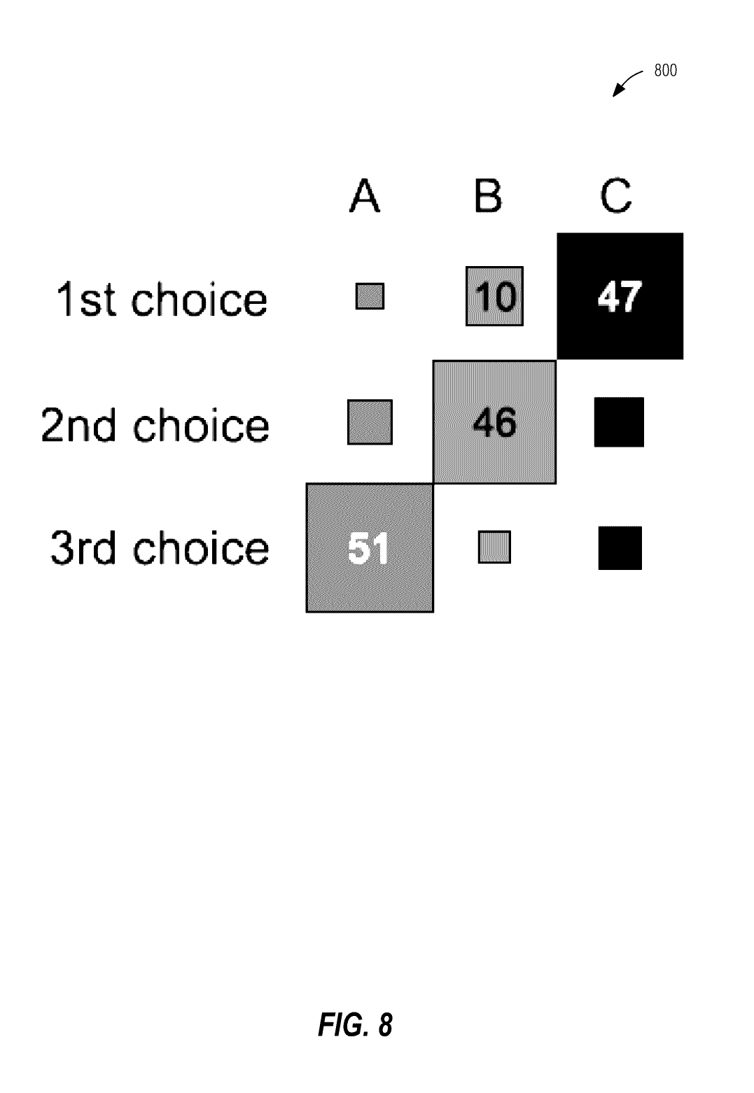

FIG. 8 shows results from interface preference post-study questionnaire 800, according to an embodiment. In the post-study questionnaire, users were asked to rank the three interfaces (“Which interface did you like best/would you choose to use for a real task?”). There is a significant difference in ranking according to Friedman's test (χ2 (2)=71.42, p<10-15). Pairwise comparisons (with Bonferroni's correction applied) indicated that all pairwise differences are significant. 80% of the users selected interface C as their first choice (cf. FIG. 8), supporting H3. The preference for C is 83% among tablet users and 77% among PC users, but this difference was not significant according to Wilcoxon's paired signed rank test (V=29, p=0.45).

Open-ended questions on the questionnaires revealed several interesting details, most notably an inadvertent side effect of the world-stabilization of markers: Since the markers in interface C had a constant world size, they ended up being quite large when the user got very close to the object, and were thus too large for some tasks, as described by this user: “Overall, the markers and viewpoints were extremely helpful. However . . . for the tasks where text needed to be located, the marker was much bigger than the words.” Having constant screen size, the markers in B did not have this side effect.

Several users expressed their preference for interface C, but commented that too many keys had to be memorized: “[C] was more useful . . . but it was sometimes difficult to remember which buttons would navigate to which screen shots, what to press to unfreeze the pane, and so on. However, I imagine it would get much easier with additional practice”; “[C] was by far the most helpful user interface, but it was a bit difficult to use due to the [number of] buttons.”

To summarize the results, an overwhelming majority of the participants (in both roles) preferred the system over both baselines (H3 supported); users performed significantly faster with it than with a video-only baseline (H1 supported); but no significant difference in task performance was found in comparison with a static marker condition (H2 not supported).

Regarding differences in task performance, we note two particular artifacts of the study design that may have reduced the differences in task performance between the interfaces in general and counteracted potential benefits of interface C in particular:

First, as users started, the difficulty of verbally giving spatial and directional instructions—including confusion regarding “left” and “right” (relative to the car's driving direction or the user's perspective?) and “up” and “down” (in world or screen coordinates?), as well as misidentification of elements—was very apparent, which supports the need for spatial annotations. However, as an artifact of the training, the within-subjects design, and the small task environment, users quickly became experts in giving and understanding directions for this particular task, possibly more so than becoming experts in using the interfaces. Oftentimes, users came up with names for different parts of the engine, which did not have to be technically accurate in order to be effective (the most creative moniker may have been “rainbow keyboard” for the fuse box). As one user commented when asked about the usefulness of the camera control: “[It] wasn't very useful since I already knew the layout of the engine from previous tasks.” For real applications, we might assume the opposite: users become familiar with the interfaces available to them and communicate with new partners in new environments. To account for this, different environments could be used for each training and interface session, which however poses a challenge in terms of practicality and ensuring fair conditions across all sessions.

Second, because of the increasingly familiar environment, and additionally motivated by the incentives, the tasks became very fast-paced. Thus, the remote user's mental load of understanding the next instructions (cf. FIG. 4), aligning them with his/her mental model of the engine, and then with his/her view of the scene, was oftentimes slower than the actual task execution, which required little physical labor and could thus be completed very quickly. As the time-critical path shifted from the local to the remote user, a potential benefit of the virtual camera control—namely, that the remote user could browse and familiarize him/herself with the environment (e.g., for the next task)—became less relevant, while a potential downside (increased complexity) became more relevant. One user commented: “Using the multiple views was a little more hectic on the ‘expert's’ side, but only because we were trying to complete the tasks as quickly as possible. In a situation in which this technology would be used, this feature would no doubt be very helpful for quality and efficiency of task completion.” This is also an artifact of the study setup: in a real application, no simulated expert knowledge has to be understood, and the local user's task may require more physical labor or travel.

Other factors may have played a role. While the users' ratings suggest that they did not perceive interface C as more difficult to use, it may require more training for optimal use (cf. comments on the number of keys above). Lastly, with C, some users took extra time to position the camera carefully to save viewpoints for later use, but the amortization of this time investment was limited by the short task duration.

In this work, in order to validate the system design and establish its usefulness, we chose a relatively simple task with clearly defined roles, as commonly used in this context. It is important to study more complex collaborative tasks. As the features that the system provides are very general in nature, we are confident that they provide benefits in a variety of contexts.

This system was overwhelmingly preferred by users. With regard to task performance time, the study showed a significant benefit compared with only one of the two baseline interfaces. Several artifacts may have contributed to this outcome. Some of these are common to many studies of collaboration, such as small environments, proxy tasks, and simulated expert knowledge. Thus, we hope that the study also informs the design of future studies in this area. Altogether, the results demonstrate the maturity and usability of the system, as well as producing insights into which aspects of the interface can be further improved. Limitations of the system which future work might target have also been discussed above.

While the system is complex under the hood, we feel that one important advantage of the approach is that it seamlessly extends the ubiquitous videoconferencing paradigm; it adds to it, but it does not take anything away. If desired, the user can fall back to simply watching the live video feed.

In the bigger picture, the work bridges and creates a synergy between video conferencing (Skype, Apple FaceTime, Google Hangouts, etc.) and remote world exploration (Microsoft Photosynth, Quicktime VR, Google StreetView, etc.) in a unique coherent interface via live collaborative AR. However, the prototype has only started to tap into the significant potential of this synergy. Areas to explore include the integration of more complex annotations such as gestures or gaze in a world-stabilized manner and the integration of cloud-based data (e.g., maps/larger models of the environments). The live navigation of remote worlds—both within virtual navigation as well as in comparison with physical navigation—also warrants further investigation.

The presented paradigm is equally applicable to scenarios with shared expertise or a local expert (e.g., in an educational context), and naturally extends to more than one local user and/or more than one remote user. Here, the environment model is to integrate video streams and annotations from all users.

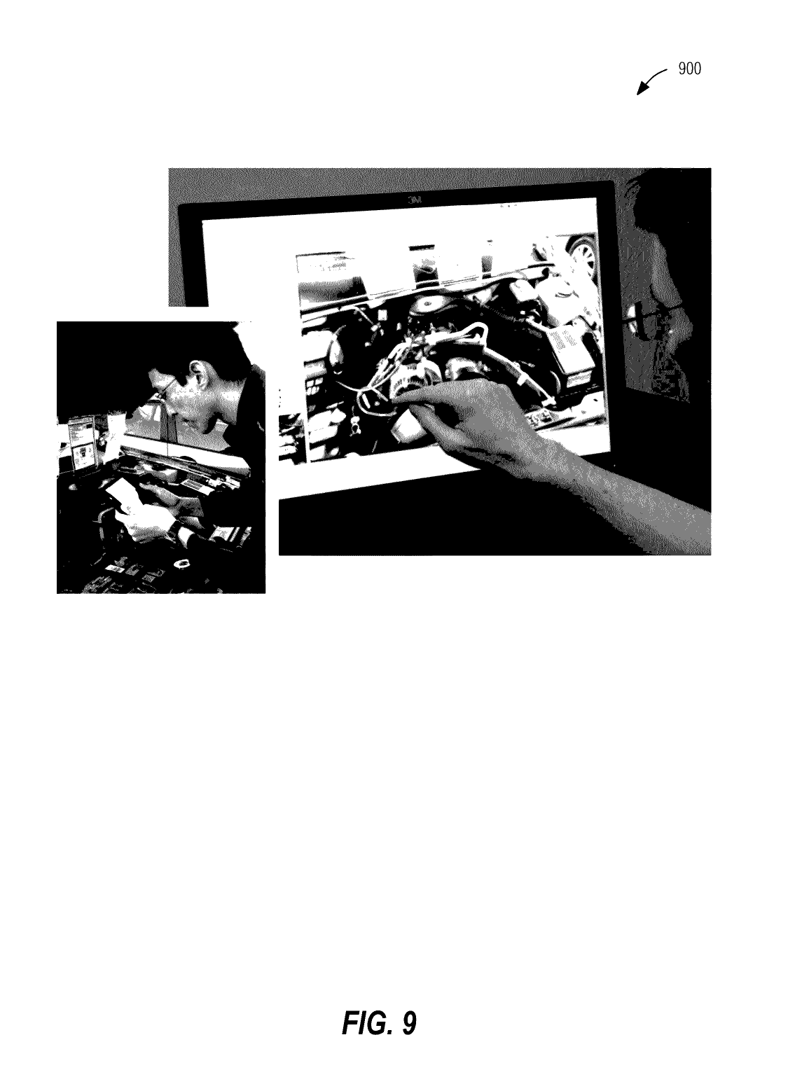

FIG. 9 shows augmented reality annotations and virtual scene navigation 900, according to an embodiment. Augmented reality annotations and virtual scene navigation add new dimensions to remote collaboration. This portion of the application presents a touchscreen interface for creating freehand drawings as world-stabilized annotations and for virtually navigating a scene reconstructed live in 3D, all in the context of live remote collaboration. Two focuses of this work are (1) automatically inferring depth for 2D drawings in 3D space, for which we evaluate four possible alternatives, and (2) gesture-based virtual navigation designed specifically to incorporate constraints arising from partially modeled remote scenes. These elements are evaluated via qualitative user studies, which in addition provide insights regarding the design of individual visual feedback elements and the need to visualize the direction of drawings.

Advances in computer vision and human-computer interaction paradigms such as AR offer the chance to make remote collaboration significantly more immersive and thus to broaden its applicability. Specifically, integrating them allows remote users to explore remote scenes based on collected imagery as well as to communicate spatial information (e.g., referencing objects, locations, directions) via annotations anchored in the real world.

An operational mobile system may be used to implement this idea. The remote user's system received the live video and computer vision-based tracking information from a local user's smartphone or tablet and modeled the environment in 3D based on this data. It enabled the remote user to navigate the scene and to create annotations in it that were then sent back and visualized to the local user in AR. This earlier work focused on the overall system and enabling the navigation and communication within this framework. However, the remote user's interface was rather simple: most notably, it used a standard mouse for most interactions, supplemented by keyboard shortcuts for certain functions, and supported only single-point-based markers.

In this application, we introduce a novel interface for the remote user in the context of this previous system that allows for more expressive, direct, and arguably more intuitive interaction with the remote world. In FIG. 9, a remote user points out an element in the environment (here: a car's engine bay) by drawing an outline around it. The annotation is world-stabilized and displayed in augmented reality to the local user (bottom left), who is holding a tablet.

Several elements of the interface are fundamentally different from similar existing work; we evaluate these novel elements of this interface via qualitative user studies. Specifically, contributions in this application include a novel touchscreen-based interface for live augmented reality based remote collaboration, the integration of 2D drawings as world-stabilized annotations in 3D, including an evaluation of how to interpret (i.e., un-project) the two-dimensional drawings in three-dimensional space, and a multitouch gesture-based virtual navigation interface designed specifically to explore partially modeled remote scenes based on a skeleton of keyframes, including multi-touch orbiting with “snap” and a hybrid approach to zoom, which combines changing the field of view and dollying.

Existing videoconferencing or telepresence systems lack the ability to interact with the remote physical environment. Researchers have explored various methods to support spatial references to the remote scene, including pointers, hand gestures, and drawings. The use of drawings for collaboration has been investigated, including recognition of common shapes (for regularization, compression, and interpretation as commands). However, in all of these works, the remote user's view onto the scene is constrained to the current view of the local user's camera, and the support for spatially referencing the scene is contingent upon a stationary camera. More specifically, when drawings are used, they are created on a 2D surface as well as displayed in a 2D space (e.g., a live video), and it remains up to the user to mentally “un-project” them and interpret them in 3D. This is fundamentally different from creating annotations that are anchored and displayed in 3D space, that is, in AR.

Some systems support world-stabilized annotations. Of those systems, some support only single-point-based markers, and some can cope with 2D/panorama scenes only. Some systems use active depth sensors on both the local and the remote user's side and thus support transmission of hand gestures in 3D (along with a different approach to navigating the remote scene); we will contrast their approach with ours in more detail.

In other areas such as computer-aided design or interactive image-based modeling, the interpretation of 2D drawings in 3D is commonly used. However, the purpose (design/modeling vs. communication), intended recipient (computer vs. human collaborator) and, in most cases, scene (virtual model vs. physical scene) all differ fundamentally from this application, and the interpretation of 2D input is typically guided and constrained by task/domain knowledge. Thus, these techniques cannot immediately be applied here.

Freehand 2D drawings have not been used before as world-stabilized annotations un-projected into 3D space for live collaboration. While freehand drawings have been used to create annotations in AR, the inherent ambiguity due to different depth interpretations has not been addressed explicitly in this context.

With respect to virtual navigation, there is a large body of work concerning 3D navigation from 2D inputs, including works specifically designed for multitouch interaction. The motivation in this application is not to propose a novel multitouch interaction to compete with those works, but rather to describe an appropriate solution given the particular constrained situation—that is, a partially modeled scene with highest rendering fidelity from a set of known viewpoints.

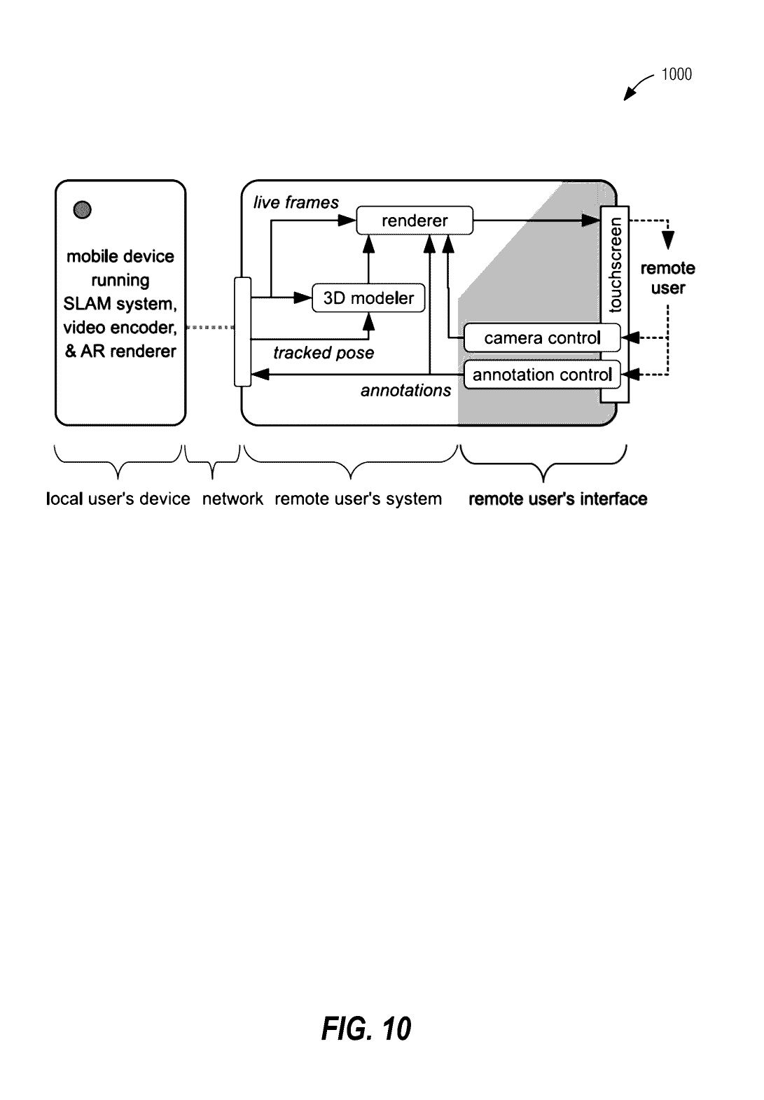

FIG. 10 shows an overview of the collaborative system 1000, according to an embodiment. The collaborative system 1000 includes local user's system (left) and remote user's system (right). In this application, we focus on the remote user's interface (highlighted area). A brief overview of the collaborative system as a whole is illustrated in FIG. 10. The local user uses a lightweight tablet or smartphone. It runs a vision-based simultaneous localization and mapping (SLAM) system and sends the tracked camera pose along with the encoded live video stream to the remote system. From there, the local system receives annotations and displays them, overlaid onto the live video, to the local user; i.e., it acts as a classic magic lens. This system was implemented as an Android app, running on several state-of-the-art Android devices.

The remote user's system may be run on one of a variety of devices, such as a commodity PC or laptop, a cell phone, tablet, virtual reality device, or other device. The embodiment shown in FIG. 10 was generated using a commodity PC. It receives the live video stream and the associated camera poses and models the environment in real time from this data. The remote user can set world-anchored annotations, which are sent back and displayed, to the local user. Further, thanks to the constructed 3D model, he/she can move away from the live view and choose to look at the scene from a different viewpoint via a set of virtual navigation controls. Transitions from one viewpoint to another (including the live view) are rendered seamlessly via image based rendering techniques using the 3D model, cached keyframes, and the live frame appropriately.

The remote user may use a standard PC interface, using the mouse and keyboard shortcuts for annotation control and virtual navigation. While the system as a whole may be received very favorably (for example, 80% of the users preferred it to the two alternative interfaces), individual elements of the remote user's interface in particular were found to be suboptimal.

Thus, in this part of the application, we concentrate on the remote user's interaction with the system, and we present and evaluate a new interface for it (highlighted area in FIG. 10).

The feedback from users who participated in the task performance-based user study served as motivation and the initial source of feedback for this work. In that study, 30 pairs of participants used the prior system, as well as two alternative interfaces for comparison, to solve a particular collaborative task and subsequently rated the interfaces and provided comments. These users are referred to as group 1.

Novel elements were incorporated and the design was iterated as described in the following sections. The system was demonstrated during a three-hour open house event, where roughly 25 visitors (referred to as group 2) directly interacted with the system. Although these interactions were very brief and unstructured, we were able to observe how people intuitively used the system and which features appeared to work well.

Lastly, we asked eleven users to interact with the system following a structured protocol and provide feedback on particular design elements (group 3). They were compensated for their time commitment of about 50 minutes with US$10. Of these study participants, five were female; the age range was 18-22 years. Four stated that they were “somewhat familiar” with interactive 3D software (e.g., 3D modelers). All had used small-scale touchscreens (e.g., smartphones) on a daily basis, but only one had used large-scale touchscreens more than “occasionally to rarely.” Five of the participants had participated in the earlier task performance-based study and were thus asked to comment on the differences compared to the earlier design. This user feedback is reported in the respective design sections below.

The remote user uses a touchscreen interface for all interactions with the system. In this section, we describe the main elements of the graphical user interface before focusing on two particular aspects—namely, the use of 2D drawings as world-stabilized annotations in 3D and gesture-based virtual navigation.

There is significant motivation for using a touchscreen as a 3D input. One argument is that, for interaction in a three-dimensional space, one should use an interface, which affords three-dimensional input and thus can, for example, create annotations in 3D. A prototype system may use three-dimensional input for the purpose of remote collaboration, by reconstructing the remote user's hand in 3D and transferring this reconstruction and 3D “motion trail” into the local user's space.

However, even if sensors that support untethered, unobtrusive 3D input (e.g., high-resolution active depth sensors) become commonplace, additional issues remain. First, unless such sensors are matched with an immersive 3D display that can synthesize images in any physical space (such as a stereo head-worn display), the space in which the input is provided and the space in which objects are visualized remain separate, in much the same way as is the case with a standard computer mouse. This has the effect that relative spatial operations are very natural and intuitive (e.g., moving the mouse cursor downwards/indicating a direction in 3D, respectively), but absolute spatial operations (e.g., pointing to an object, which is arguably very important in this context) remain indirect and require the user to first locate the mouse cursor/representation of the hand, respectively, and position it with respect to the object of interest. Second, even with such an immersive 3D display, haptic feedback is typically missing.

In contrast, touchscreens are not only ubiquitous today, but they afford direct interaction without the need for an intermediate representation (i.e., a mouse cursor), and provide haptic feedback during the touch. In this context, however, they have the downside of providing 2D input only. Discussing the implications of this limitation and describing and evaluating appropriate solutions in the context of live remote collaboration is one of the main contributions of this application.

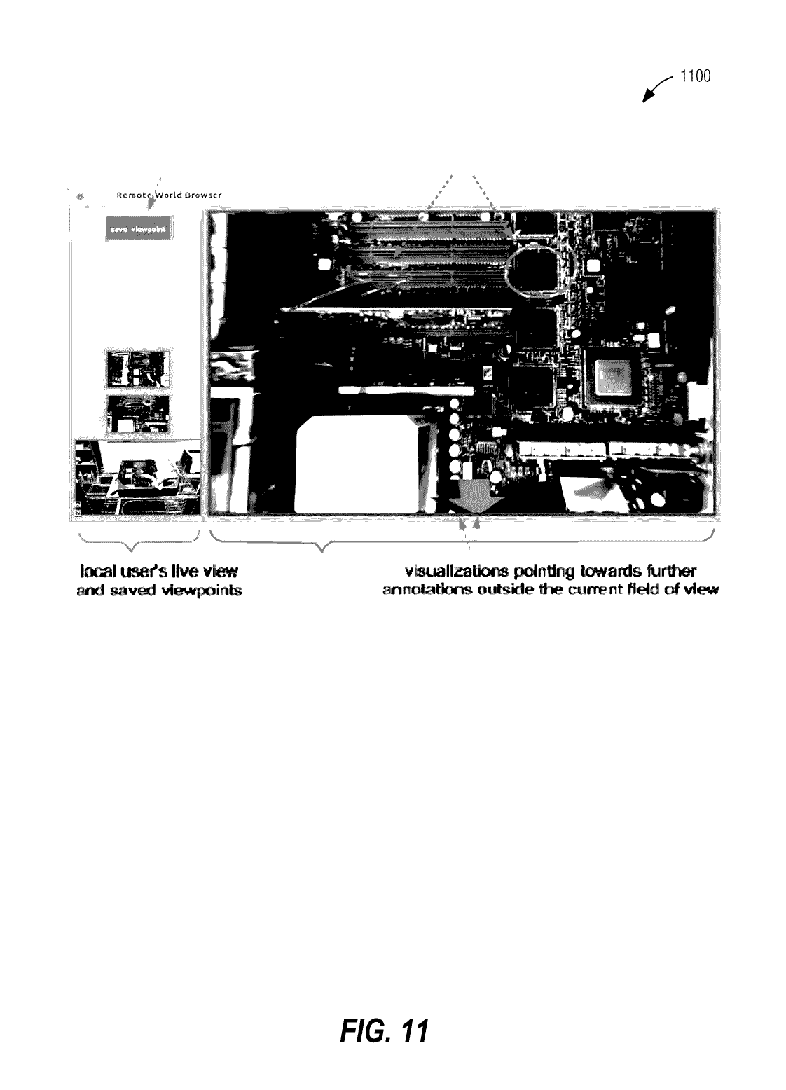

FIG. 11 shows a screenshot of the remote user's touchscreen interface 1100, according to an embodiment. FIG. 11 presents the elements of the graphical user interface. The main part of the screen shows the main view, in which annotations can be created and gesture-based virtual navigation takes place. A side pane contains, from top to bottom, (1) a button to save the current viewpoint, (2) small live views of saved viewpoints, and (3) the local user's live view (whenever the main view is not identical to it). A tap onto any of the views in the side pane causes the main view to transition to that respective viewpoint.

A two-finger tap onto the main view while it is coupled to the local user's live view freezes the current viewpoint. Note that only the viewpoint is frozen; the live image is still projected into the view.

When the user starts to draw an annotation while the main view is coupled to the (potentially moving) live view, the viewpoint is temporarily frozen in order to enable accurate drawing. In this case, the view automatically transitions back to the live view as soon as the finger is lifted. This feature was particularly well received by group 2.

Thus, all interface functions are immediately accessible on the screen, allowing quick access and avoiding the need to memorize keyboard shortcuts (which was noted as a drawback in the previous system by group 1).

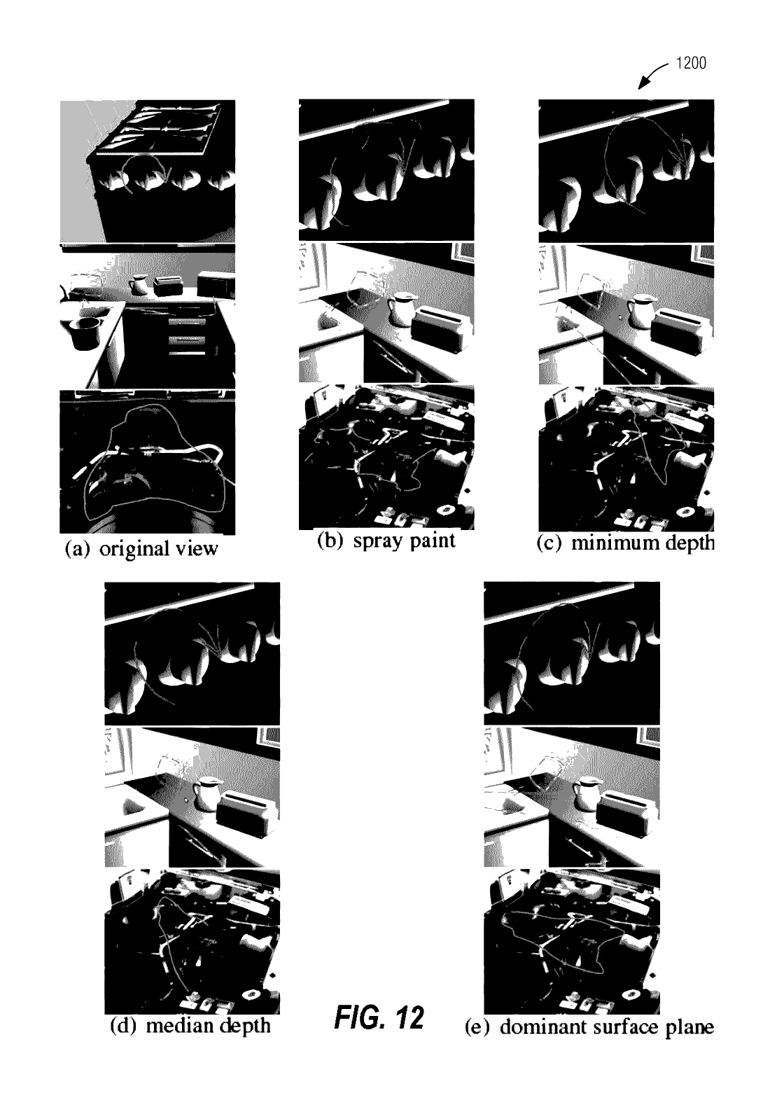

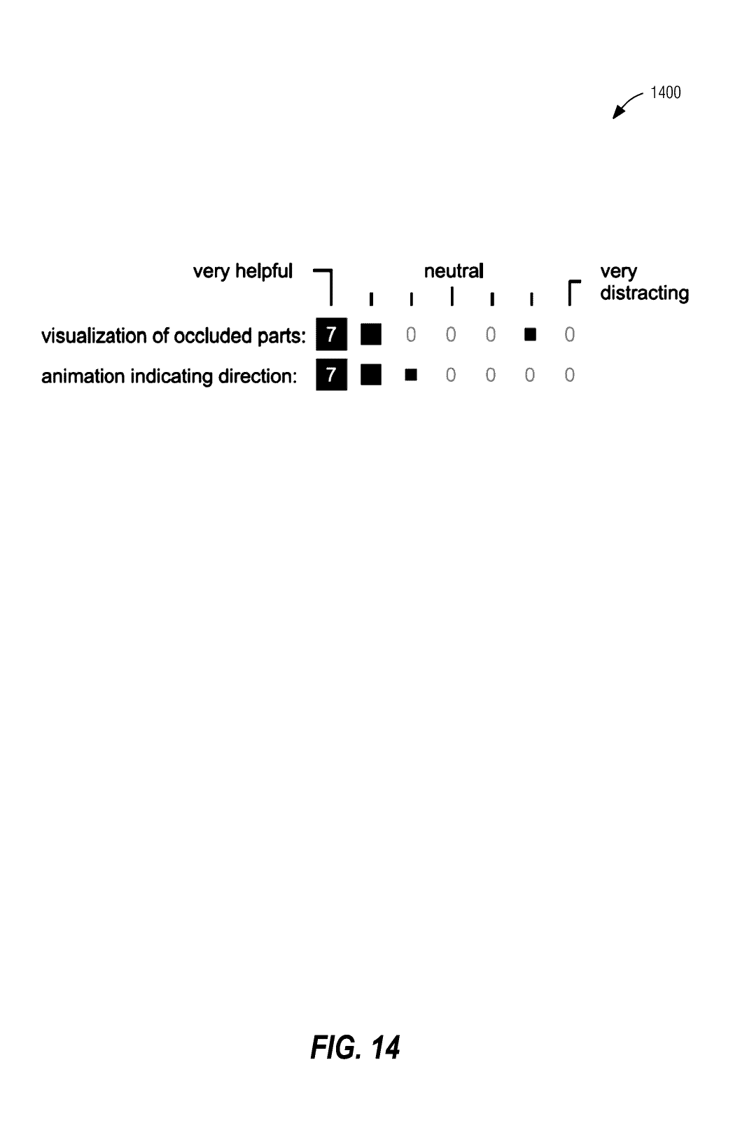

FIG. 12 shows depth interpretations of 2D drawings 1200, according to an embodiment. In each row, (a) shows the viewpoint from which the drawing was created, and (b-e) show different depth interpretations from a second viewpoint (all interpretations have the same shape if seen from the original viewpoint). Annotation segments that fall behind object surfaces are displayed semi-transparently, which was deemed “very helpful” by 7 of 11 users (cf. FIG. 14).

Using a single finger, the remote user can draw annotations into the scene. A few examples are shown in FIG. 12(a). Since the camera is tracked with respect to the scene, these annotations automatically obtain a position in world coordinates. However, due to the use of a touchscreen, the depth of the drawing along the current viewpoint's optical axis is unspecified.

In principle, it is possible to ask the user to provide depth explicitly, for example by providing a second view onto the scene and having the user shift points along the unspecified dimension. This may be appropriate for professional tools such as CAD. However, in this case, we want to enable the user to communicate spatial information quickly and effortlessly, such as with hand gestures in face-to-face communication. Thus, we concentrate on ways to infer depth automatically. In this section, we discuss and evaluate several alternatives to do so.

A basic assumption is that the annotation shall be in contact with the 3D surface in some way; i.e., annotations floating in midair may be implemented.

Given an individual 2D input location p=(x, y), a depth d can thus be obtained by un-projecting p onto the model of the scene. For a sequence of 2D inputs (a 2D drawing) p₁, . . . , pₙ, this results in several alternatives to interpret the depth of the drawing as a whole, of which we consider the following:

“Spray paint”: Each sample pᵢ is assigned its own depth dᵢ independently; the annotation is thus created directly on the 3D surface as if spray-painted onto it (FIG. 12(b)).

Plane orthogonal to viewing direction: The annotation is created on a plane orthogonal to the viewing direction. Its depth can be set to any statistic of {di}, for example, the minimum (to ensure that no part of the annotation lands behind surfaces) (FIG. 12(c)) or the median (FIG. 12(d)).

Dominant surface plane: Using a robust estimation algorithm such as RANSAC or Least Median of Squares, one can estimate the dominant plane of the 3D points formed by {pi} and the associated {di} and project the drawn shape onto this plane (FIG. 12(e)).

All of these approaches appear to have merits; which one is most suitable depends on the context and purpose of the drawing. Spray paint appears to be the logical choice if the user intends to “draw” or “write onto” the scene, trace specific features, etc. Note that projective displays—used for remote collaboration for example by and appealing due to their direct, un-mediated overlay of annotations—can intrinsically only produce spray paint-like effects, unless not only the projector, but also the user's eyes are tracked and active stereo glasses (synced with the projector) are used in order to create the illusion of a different depth.

For other types of annotations, planarity may be preferable. To refer to an object in its entirety, the user might draw an outline around the object. Drawings used as proxies for gestures—for example, drawing an arrow to indicate a direction, orientation, or rotation (cf. FIG. 12 top two rows)—are likely more easily understood if projected onto a plane.

Another aspect for consideration, especially in the case of models reconstructed via computer vision, is the sensitivity to noise and artifacts in the model. A spray-painted annotation may be unintelligibly deformed and the minimum depth plane may be shifted. The median depth and dominant plane are more robust as single depth measurements carry less importance.

In order to test the hypotheses above, we asked the users from group 3 to communicate a piece of information to a hypothetical partner via a drawing. For example (for FIG. 12(a) top to bottom): “In which direction do you have to turn the knob?”; “Where should the microwave be placed?”; “Where is the motor block?” The scene was shown with the drawn annotation from a different viewpoint and the users were asked which of the four depth interpretations (FIG. 12(b-e)) was the most suitable interpretation for their particular drawing.

A range of different questions was asked to prompt a variety of drawings. Scenes were used in which the original viewpoint was roughly perpendicular to the object's main surface (FIG. 12 top) as well as slanted surfaces (FIG. 12 middle and bottom row). Further, to be able to distinguish conceptual issues from sensitivity to noise, we used both virtual models (FIG. 12 top and middle row) and models created by the system via SLAM and approximate surface modeling (FIG. 12 bottom). Situations were avoided in which all variants result in the same or nearly the same shape, that is, single planar surfaces. In total, we asked each user for 27 drawings, in four different environments.

The users were not told how they should communicate the information, and thus the drawn shapes varied appreciably in nature. For example, to refer to a particular object, some users traced the object's outline (similar to FIG. 12 bottom), some circled it loosely, and others drew an arrow pointing towards it.

Users used arrow-like drawings in several contexts, for example, to indicate a direction of rotation (e.g., FIG. 12 top). However, the type of arrowhead varied. Table 2 shows usage of different styles of arrow heads initially and after an animation visualizing the drawings' direction was introduced:

| arrow head | none | attached | detached |
|---|---|---|---|
| example | 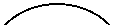 | 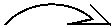 | 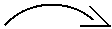 |
| initially: | 24.6% | 23.1% | 52.3% |
| with animation: | 72.3% | 15.4% | 12.3% |

Initially, roughly one quarter of all arrows was drawn without head; that is, the shape itself does not actually convey the direction. Users evidently assumed that the direction of the drawing would implicitly be communicated. As the drawings assume the role of gestures (and one would rarely add an arrowhead with a hand gesture motioned in mid-air), this assumption is reasonable.

This variant was anticipated due to prior observations (e.g., with users from group 2) and thus implemented an animated visualization to do so: here, the line contains lighter dashes, which flow in the direction in which the line was drawn. The design was inspired by the visual appearance of animated Line Integral Convolution and can loosely be thought of as a coarse approximation for it for a single dimension and constant speed. Thus far, we use a fixed speed of flow, but one could extend this visualization by additionally visualizing the speed of drawing via the speed of flow.

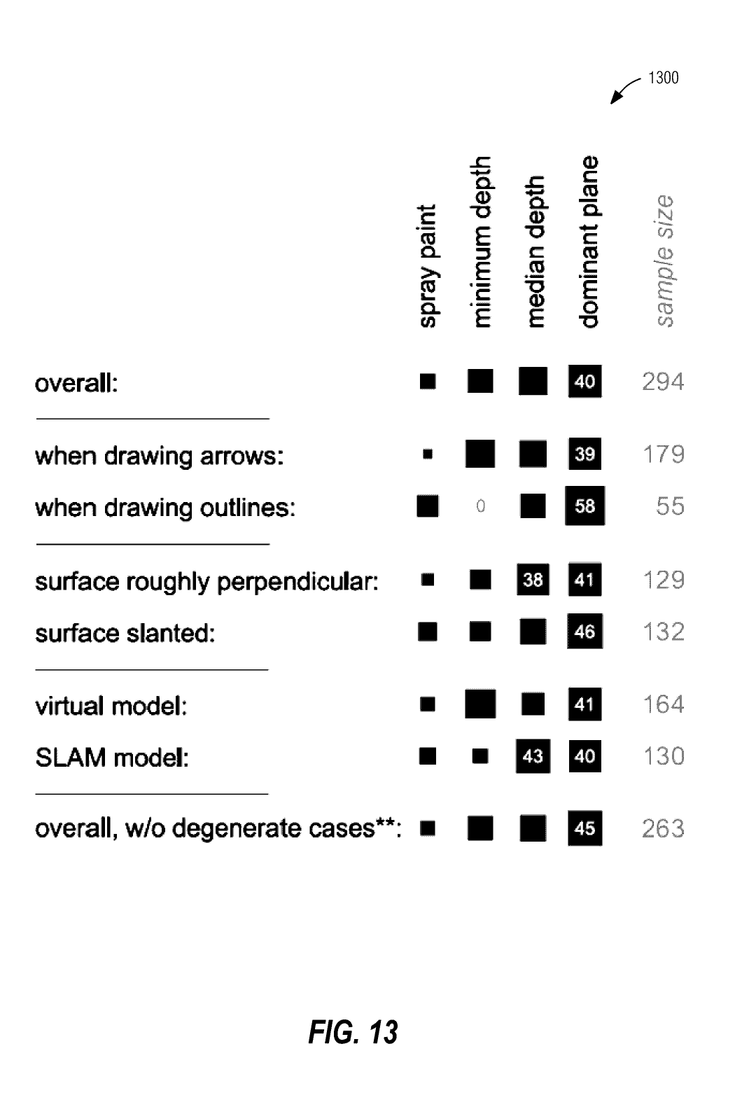

FIG. 13 shows user preference among the four different depth interpretations 1300, according to an embodiment. FIG. 13 details the users' preference broken down by various subsets. Overall, in every category, users tended to prefer the planar projections in general, and the dominant plane version in particular, which was the most frequently chosen variant in every category but one. As shown in FIG. 13, user preference is broken down by various subsets. Per each row, the areas of the squares and the numbers indicate the preference for a particular variant in percent.

FIG. 14 shows ratings of two visualization options 1400, according to an embodiment. The animation shown in Table 2 above was introduced after the first six drawings for each user. After introducing the animation, almost three quarter of all arrows were drawn without head. As shown in FIG. 14, the animation was rated as “very helpful” or “helpful” by 10 of 11 users, and even though it was not necessary for some of the drawings, no users perceived it as distracting.

Drawings may be treated as separate annotations as soon as the finger is lifted, which means that they are moved onto separate planes by the three planar projection methods (cf. FIG. 12(c-e) middle row). Individual segments that are created in very close succession—such as a detached head for an arrow, which was by far the most commonly used style of arrow before we introduced the animation indicating direction (cf. Table 2)—should ideally be treated as one entity.

Further, the “dominant plane” method is susceptible to extreme artifacts if the points lie on or close to a single line, such as seen in FIG. 12(e) middle row. When removing the cases in which this occurred from consideration, the general preference for the dominant plane version increases further (last row in FIG. 13). In future work, these degenerate configurations should be detected and one of the other variants (e.g., median depth) used instead.

Naturally, there are several cases in which none of these options will work satisfactorily, such as when trying to create an annotation in mid-air or behind physical surfaces. Of course, an interface may also offer to change the type of depth inference used, e.g., for advanced users. Even for 2D only, some interfaces offer a whole array of drawing tools; however, it has been reported that users use freehand drawing most often. With this consideration, the quest here is to find out what the default setting should be, such that gestures used in face-to-face communication can be emulated as efficiently as possible.

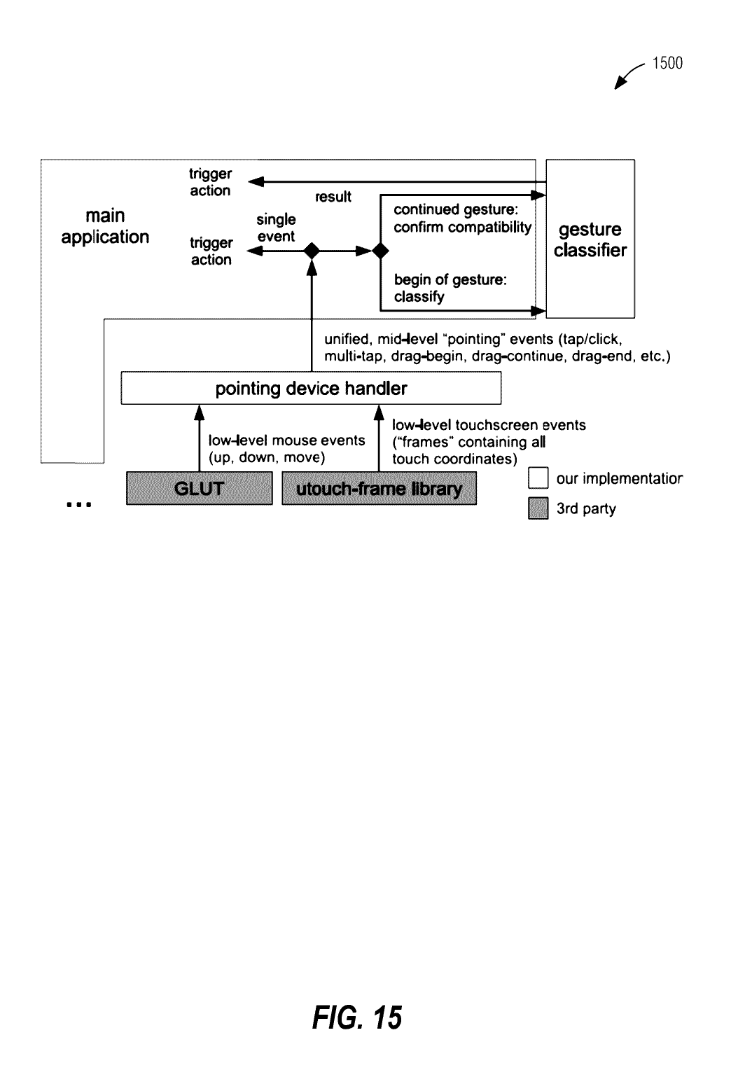

FIG. 15 shows various navigation features 1500, according to an embodiment. As discussed above, the user can freeze the viewpoint (FIG. 15(a)), save the current viewpoint, and go to the live view or any previously saved view (FIG. 15(b)), all with a single tap onto the respective region in the interface. In addition, we implemented gesture-based navigation controls (FIG. 15(c)-(e)) which we will discuss in this section. As a distinguishing element from drawing annotations, all navigation-based controls on the main view are triggered by two fingers.

While we want to empower the remote user to explore the scene as freely as possible, only parts of the scene that have previously been observed by the local user's camera are known and can be rendered. From the incoming live video, we store keyframes based on a set of heuristics, which are used as a kind of “skeleton” for the navigation.

Thus, from a more or less sparse set of camera poses, we want to find paths/transitions that can be mapped to specific input controls. However, in contrast to their work, we do not attempt to mine longer paths and suggest them to the user, but rather to find suitable transitions given a user's specific input.

For all gestures, we designed the controls such that the 3D scene points underneath the touching fingers follow (i.e., stay underneath) those fingers throughout the gesture (i.e., “contact trajectories match the scene transformations caused by viewpoint modifications”) as far as possible.

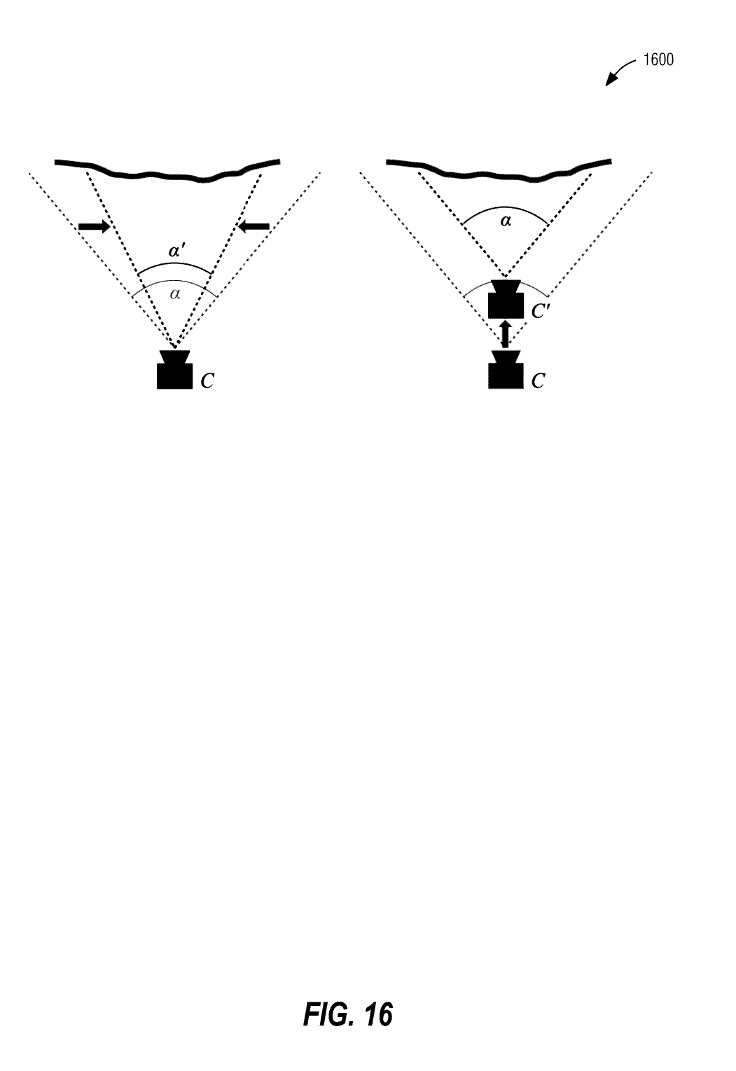

FIG. 16 shows a software stack for processing events from pointing devices 1600, according to an embodiment. The software stack that we implemented to process the touchscreen and mouse input is depicted in FIG. 16. A pointing device handler receives low-level mouse and touchscreen events (from GLUT and the Ubuntu utouch-frame library, respectively) and generates events that are unified across the devices and of slightly higher level (e.g., recognize “click”/“tap” from down+(no move)+up events, distinguish from drag-begin, etc.). These events are received by the main application. Multi-stage events (i.e., gestures) are sent on to a gesture classifier, which classifies them or, after successful classification, validates the compatibility of the continuing gesture. The gesture classifier operates on relatively simple geometric rules (e.g., for swipe, the touch trails have to be of roughly the same length and roughly parallel), which worked sufficiently for these purposes, as the qualitative evaluation confirmed.

By moving two fingers in parallel, the user can pan, i.e., rotate the virtual camera around its optical center (FIG. 15(c)). The original up vector is maintained (typically: gravity, as reported by the local user's device) by keeping track of the original camera position, accumulating increments for yaw and pitch separately and applying one final rotation for each yaw and pitch (rather than a growing sequence of rotations, which would skew the up vector).

As we will typically have imagery of part of the remote scene only, we constrain the panning to the angular extent of the known part of the scene. To ensure that the system does not appear unresponsive to the user's input while enforcing this constraint, we allow a certain amount of “overshoot” beyond the allowed extent. In this range, further swiping causes an exponentially declining increase in rotation and visual feedback in the form of an increasingly intense blue gradient along the respective screen border. If the fingers are lifted off the screen at this moment, the panning snaps back to the allowed range.

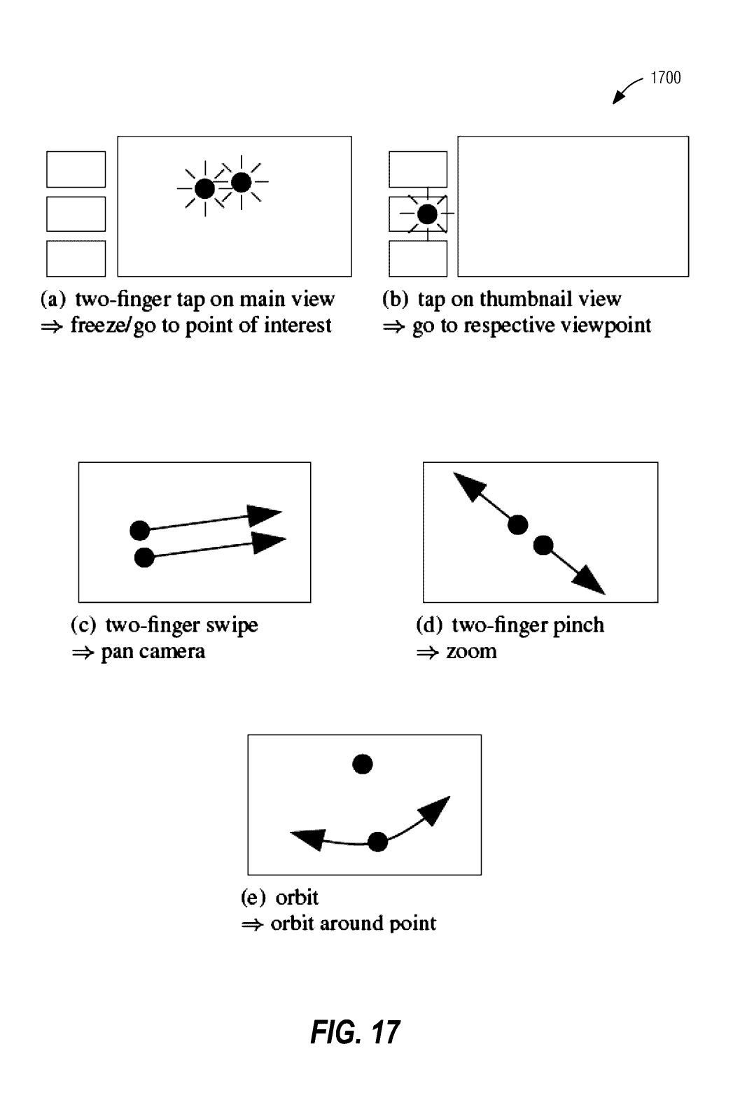

FIG. 17 shows a method of zooming in 1700, according to an embodiment. There are two different ways of implementing the notion of “zoom” in 3D: either via modifying the field of view (FOV) (FIG. 17 left) or via dollying (i.e., moving the camera forward/backward; FIG. 9 right). For objects at a given depth, both changes are equivalent; differences arise due to varying depths (i.e., parallax). Which motion is desired by the user may depend on the particular scene. Given the large overlap in effect, we wanted to avoid providing two separate controls.

In this context, with an incomplete and/or imperfect model of the environment, changing the FOV has the advantage that it is trivial to render, while rendering a view correctly after dollying the camera might be impossible due to occlusions. However, changing the FOV disallows exploration of the scene beyond a fixed viewpoint, and its usefulness is limited to a certain range by the resolution of the image.

Here, we thus propose a novel hybrid approach: changing the FOV to allow for smooth, artifact-free, fine-grained control combined with transitioning to a suitable keyframe, if available, in front or behind the current location for continued navigation. The availability of a keyframe automatically implies that it may be reasonable to move there (e.g., walk in this direction), while free dollying has to be constrained intelligently to not let the user fly through the physical surface when his/her intent may have been to get a close-up view. This hybrid solution was implemented as follows.

Given a two-finger “pinch” gesture (FIG. 15(d)) with start points s1 and s2 and end points e1 and e2, we first calculate the change in FOV that corresponds to the change in distance |s1−s2| to |e1−e2|. Yaw and pitch were adapted such that the scene point under (s1+s2)/2 are mapped to (e1+e2)/2. (Roll is disallowed on purpose, as it is rarely used or needed.)

To determine if transitioning to a different keyframe is in order, we determine the 3D world points {cᵢ^{3D}}, i=1 . . . 4, which, with the modified projection matrix, are mapped into the corners of the view {cᵢ}. The ideal camera pose R is the one that projects {c^{3D}} to {cᵢ} with its native projection matrix P (i.e., unmodified FOV). Therefore, we project {cᵢ} using the camera pose of each of the stored keyframes, and select the camera k* for which the points land closest to the image corners {cᵢ}; i.e.,

$${k}^{*} = arg {min}_{k} {\sum }_{i = 1}^{4} \vert P \cdot {R}_{k} \cdot {c}_{i}^{3 D} - {c}_{i} {\vert}^{2} \qquad ( 1 )$$

To ensure that the transition is consistent with the notion of dollying, we only consider cameras whose optical axis is roughly parallel to the current camera's optical axis.

If k* is not identical to the current camera, we thus transition to Rₖ* and adapt FOV, yaw and pitch again as described above. A hysteresis threshold can be used to avoid flip-flopping between two cameras with nearly identical score according to Equation (1).

In effect, the user can “zoom” through the scene as far as covered by available imagery via a single, fluid control, and the system automatically choses camera positions and view parameters (FOV, yaw, pitch) based on the available data and the user's input.

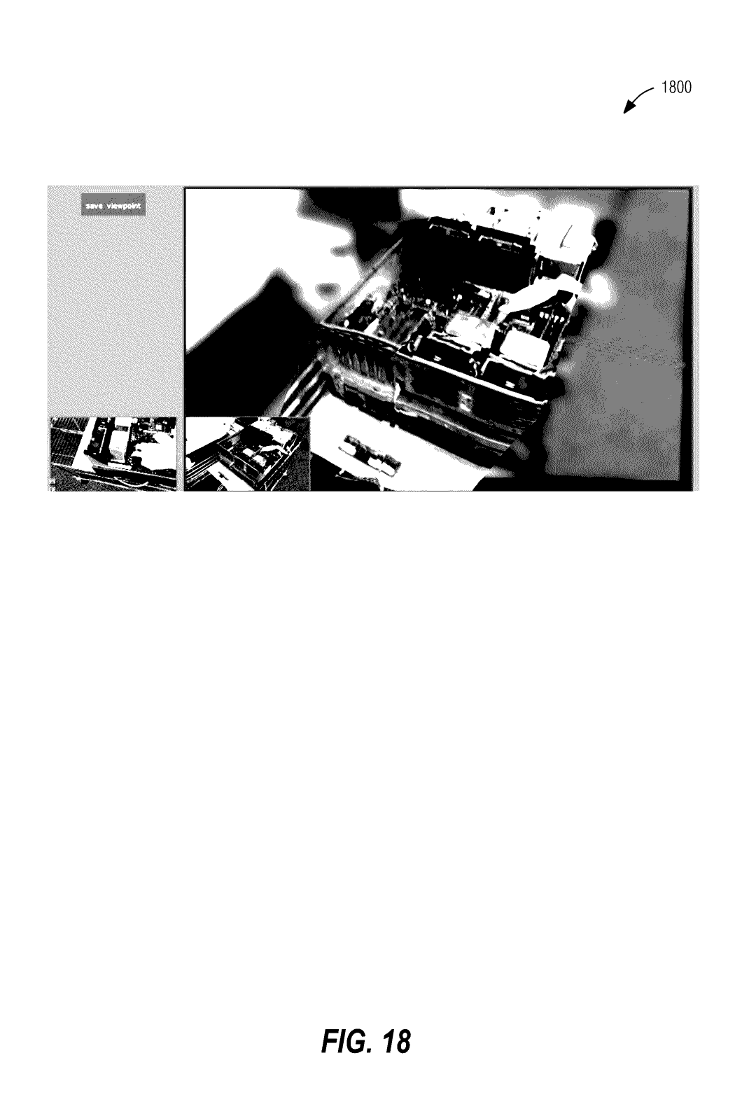

FIG. 18 shows a screenshot during an orbit operation 1800, according to an embodiment. As a third gesture, we added orbiting around a given world point p^{3D}. The corresponding gesture is to keep one finger (relatively) static at a point p and move the second finger in an arc around it (FIG. 15(e)). The orbit center p^{3D} is determined by un-projecting p onto the scene and remains fixed during the movement; additionally, we maintain the gravity vector (as reported by the local user's device). The rotation around the gravity vector at p^{3D} is then specified by the movement of the second finger.

Again, we want to guide the user to keyframe positions if possible as the rendering from those positions naturally has the highest fidelity. Thus, once the user finishes the orbit, the camera “snaps” to the closest keyframe camera pose. In FIG. 18, the two visualizations of the “snap” position. The inset image in the bottom left corner of the main view previews the target image and the red line connects the orbit point and the target camera origin. The idea of orbiting constrained to keyframes addresses orbit paths, where possible orbit paths are mined from the set of pictures and then suggested to the user for exploration of the scene, but differs in that we do not find paths beforehand, but find a suitable transition given the user's input.

Selection of the “snap” target pose. Given the list of available camera positions, we first filter out all cameras for which p^{3D} is not within the field of view. Among the remaining poses {Rₖ}, we select the one closest to the camera pose Rᵢₙₚᵤₜ at which the user ended the orbit:

$${k}^{*} = arg {min}_{k} d ( {R}_{k} , {R}_{input} ) \qquad ( 2 )$$

where the distance d(•, •) between two camera poses is defined as follows:

$$d ( {R}_{1} , {R}_{2} ) = \{ \begin{matrix}\frac{{d}_{t} ( {R}_{1} , {R}_{2} )}{{d}_{∡} ( {R}_{1} , {R}_{2} )} & if {d}_{∡} ( {R}_{1} , {R}_{2} ) > 0 \\ ∞ & otherwise \end{matrix} \qquad ( 3 )$$

where dₜ(•, •) is the translational distance between the camera origins, and d [symbol] (•, •) is the dot product of the opticalaxes.

During an on-going orbit process, we provide two visualizations that indicate where the camera would snap to if the orbit ended at the current location (see FIG. 10): First, we display the would-be target keyframe as a preview in a small inset in the bottom left corner of the main view. Second, we display a semi-transparent red line from the orbit point p^{3D} to the would-be target camera origin. While less expressive than the preview image, this visualization has the advantage of being in-situ: the user does not have to take their eyes off the model that he/she is rotating. Minimal visualization was used (instead of, for example, visualizing a three-dimensional camera frustum) in order to convey the essential information but keep visual clutter to a minimum.

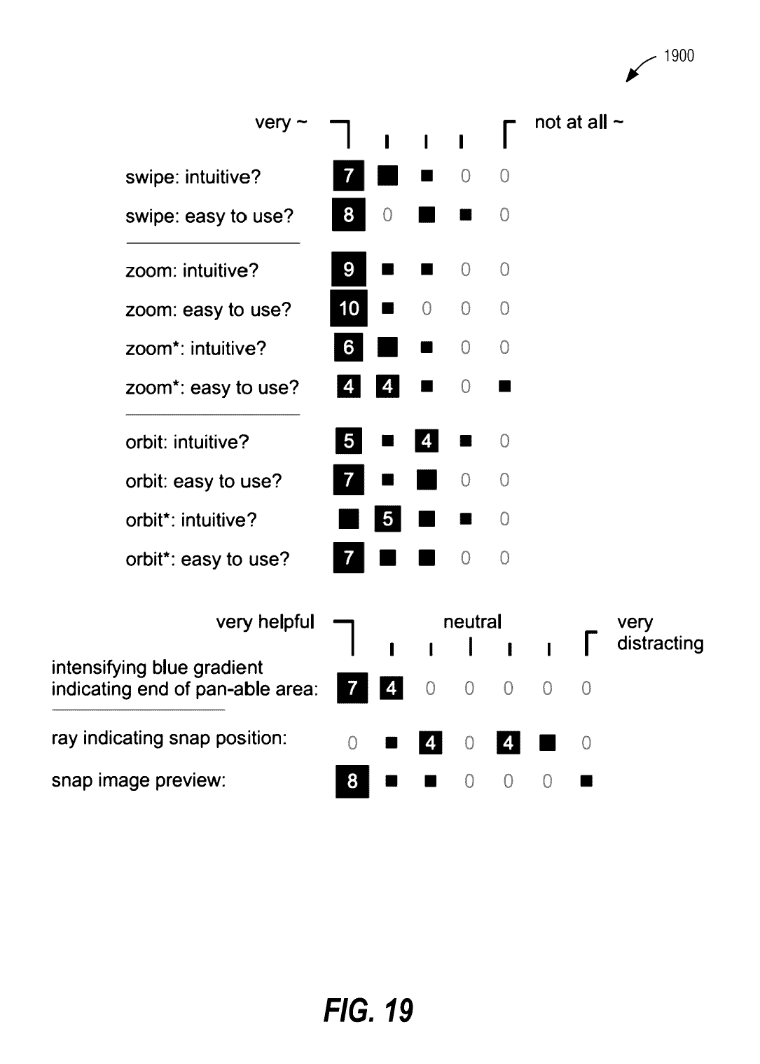

FIG. 19 shows ratings of various navigation elements 1900, according to an embodiment. In FIG. 19, the areas of squares are proportional to the number of users. Users from group 3 were asked to try out the individual navigation controls and rate them. The results are aggregated in FIG. 19.

After having been told only that two-finger gestures would control the camera (since one-finger gestures draw annotations), and asked to pan, all users intuitively guessed the gesture (i.e., swipe) correctly—unsurprisingly, perhaps, given their exposure to touchscreen interfaces—and were able to control the camera as suggested; the control received high ratings in terms of both intuitiveness and ease of use. Additionally, all users correctly identified what the intensifying blue gradient communicated; this visualization was rated as “very helpful” by 7 of 11 users, and as “helpful” by the others.

For zooming, again all users intuitively guessed the gesture (i.e., pinch) correctly and were able to control the camera as suggested. Users try out zoom first with the transitional component disabled, i.e., only the FOV was changed. This control was given the highest rating on a 5-point scale for intuitiveness and ease of use by 9 and 10 out of 11 users, respectively. With transitional component enabled (labeled “zoom*” in FIG. 19), the control still received high ratings, though clearly lower than without. Several users appreciated the fact that it transitioned to other frames and thus allowed to zoom further; however, the decreased smoothness and possibility of being “stuck” were noted as downsides. The idea of using a hysteresis threshold to decrease artifacts was a result of this feedback (i.e., it was not implemented at the time of this evaluation).

For orbiting, we first introduced the control on a virtual model without any constraints/snap-to-keyframe. While the ratings for intuitiveness are lower than for the other methods, the ratings for ease of use are similar. With snap-to-keyframe, on a model reconstructed from images (labeled “orbit*” in FIG. 19), the ratings are very similar, suggesting that the constraint was not irritating. The two visualizations received very different ratings, however: while the preview image was rated as “very helpful” by 8 of 11 users, the red line was perceived as “(somewhat or slightly) helpful” by only half the users, and as “(somewhat or slightly) distracting” by the other half. Conversations made clear that despite explanations, not all users understood and/or saw value in this visualization.

A touchscreen interface was presented via which a remote user can navigate a physical scene (which is modeled live using computer vision) and create world-stabilized annotations via freehand drawings, thus enabling more expressive, direct, and arguably more intuitive interaction with the scene than previous systems using mouse-based interfaces. Contributions include the design and qualitative evaluation of gesture-based virtual navigation controls designed specifically for constrained navigation of partially modeled remote scenes, and the integration of freehand drawings including the analysis and evaluation of different alternatives to un-project them into the three-dimensional scene. While 2D drawings for communication have previously been explored, new challenges arise when integrating them into an immersive AR framework.

With respect to the gesture-based virtual navigation, we suggest that the consistently high ratings indicate that the controls are designed appropriately. By design, the controls are dependent on the viewpoint coverage provided by the local user. Further features may include ensuring that the user cannot be “stuck” in the case of unfavorable viewpoint distributions.

With respect to the interpretation of 2D drawings in 3D, given the results, we suggest that a planar interpretation of the drawings is most likely the most useful default in the context of remote collaboration, in particular if their implementation takes into account two aspects that have been identified above (namely, segments created in close succession should be grouped, and degenerate cases for the case of dominant plane estimation should be identified and avoided). Additionally, it has been demonstrated that it is important to visualize the direction in which the annotations are drawn.

The system may be extended to combine methods. In an example, a method could choose the dominant plane if the fraction of supporting inliers is large and median depth plane otherwise. In another example, a method could attempt to recognize particular shapes and use this information in interpreting their shape in 3D. The interpretations are not required to assume semantic knowledge of any kind about the scene; if such knowledge and/or 3D segmentations are available, this may enable higher-level interpretations.

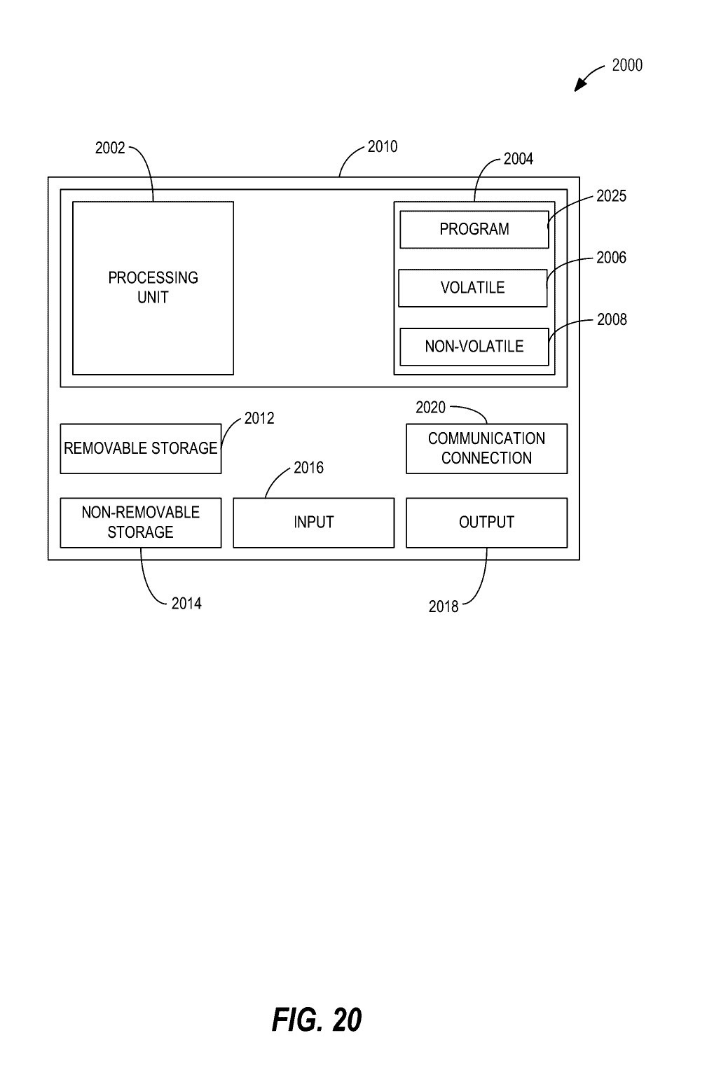

FIG. 20 is a block diagram of a computing device 2000, according to an embodiment. In one embodiment, multiple such computer systems are used in a distributed network to implement multiple components in a transaction-based environment. An object-oriented, service-oriented, or other architecture may be used to implement such functions and communicate between the multiple systems and components. In some embodiments, the computing device of FIG. 20 is an example of a client device that may invoke methods described herein over a network. In other embodiments, the computing device is an example of a computing device that may be included in or connected to a motion interactive video projection system, as described elsewhere herein. In some embodiments, the computing device of FIG. 20 is an example of one or more of the personal computer, smartphone, tablet, or various servers.

One example computing device in the form of a computer 2010, may include a processing unit 2002, memory 2004, removable storage 2012, and non-removable storage 2014. Although the example computing device is illustrated and described as computer 2010, the computing device may be in different forms in different embodiments. For example, the computing device may instead be a smartphone, a tablet, or other computing device including the same or similar elements as illustrated and described with regard to FIG. 20. Further, although the various data storage elements are illustrated as part of the computer 2010, the storage may include cloud-based storage accessible via a network, such as the Internet.

Returning to the computer 2010, memory 2004 may include volatile memory 2006 and non-volatile memory 2008. Computer 2010 may include or have access to a computing environment that includes a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. The input 2016 may include one or more of a touchscreen, touchpad, mouse, keyboard, camera, and other input devices. The computer may operate in a networked environment using a communication connection 2020 to connect to one or more remote computers, such as database servers, web servers, and other computing device. An example remote computer may include a personal computer (PC), server, router, network PC, a peer device or other common network node, or the like. The communication connection 2020 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing unit 2002 of the computer 2010. A hard drive (magnetic disk or solid state), CD-ROM, and RAM are some examples of articles including a non-transitory computer-readable medium. For example, various computer programs 2025 or apps, such as one or more applications and modules implementing one or more of the methods illustrated and described herein or an app or application that executes on a mobile device or is accessible via a web browser, may be stored on a non-transitory computer-readable medium.

### Additional Notes & Example Embodiments

Example 1 is a method for communication, the method comprising: receiving a plurality of images of a location A from an image capture device in location A; associating a plurality of localization information with the plurality of images, the plurality of localization information providing a localization data set for each of the plurality of images; and sending collaboration information to a device in location B, the collaboration information based on the localization information and based on a collaboration input.

In Example 2, the subject matter of Example 1 optionally includes receiving the plurality of localization information.

In Example 3, the subject matter of any one or more of Examples 1-2 optionally include generating the localization data set for each of the plurality of images based on the plurality of images.

In Example 4, the subject matter of any one or more of Examples 1-3 optionally include generating a location A representation based on a three-dimensional (3-D) model and the plurality of images.

In Example 5, the subject matter of any one or more of Examples 1-4 optionally include generating the 3-D model using the plurality of images and the plurality of localization information.

In Example 6, the subject matter of any one or more of Examples 1-5 optionally include receiving the 3-D model.

In Example 7, the subject matter of any one or more of Examples 1-6 optionally include wherein associating a plurality of localization information includes sending the plurality of localization information and the plurality of images to a plurality of physical computers, the plurality of physical computers configured to reduce a localization information latency and configured to reduce a latency-uncritical task load.

In Example 8, the subject matter of any one or more of Examples 1-7 optionally include wherein: the localization information includes an image capture device location and an image capture device orientation; and the localization information is generated using vision-based simultaneous localization and mapping (SLAM).

In Example 9, the subject matter of Example 8 optionally includes wherein the vision-based SLAM includes a monocular vision-based SLAM.

In Example 10, the subject matter of any one or more of Examples 4-9 optionally include receiving an annotation input.

In Example 11, the subject matter of Example 10 optionally includes freezing a viewpoint of the location A representation automatically during the receiving of the annotation input; and resuming a live location A representation following the receiving of the annotation input, wherein resuming the live location A representation includes displaying and tracking an updated viewpoint of the image capture device in physical location A, wherein resuming the live location A representation includes displaying and tracking an updated viewpoint of the image capture device in physical location A.

In Example 12, the subject matter of any one or more of Examples 10-11 optionally include generating an annotated 3-D model based on the annotation input, the 3-D model, and the plurality of images, the annotated 3-D model including a mapping of the annotation input into the 3-D scene.

In Example 13, the subject matter of Example 12 optionally includes integrating a plurality of data from external sources into the 3-D model.

In Example 14, the subject matter of Example 13 optionally includes integrating an alignment input into the 3-D model, the alignment input including information to align the plurality of data from external sources with the 3-D model.

In Example 15, the subject matter of Example 14 optionally includes wherein integrating the alignment input into the 3-D model is based on computer vision based recognition or Global Positioning System (GPS) sensors.

In Example 16, the subject matter of any one or more of Examples 12-15 optionally include wherein: the annotation input is a two-dimensional (2-D) annotation input; and generating the annotated 3-D model is further based on a mapping from the annotation input into the 3-D space, the mapping including information about an intended 3-D shape and a location of the annotation input.

In Example 17, the subject matter of any one or more of Examples 12-16 optionally include generating an annotated rendered representation in location B based on the annotated 3-D model.

In Example 18, the subject matter of Example 17 optionally includes wherein the annotated rendered representation of the annotation input includes a visualization of an annotation input direction.

In Example 19, the subject matter of Example 18 optionally includes wherein the visualization includes a flow animation.

In Example 20, the subject matter of any one or more of Examples 17-19 optionally include wherein the annotated rendered representation of the annotation input is adapted in size based on an observer viewpoint proximity.

In Example 21, the subject matter of Example 20 optionally includes wherein the adaption in size is non-linear with respect to the observer viewpoint proximity.

In Example 22, the subject matter of any one or more of Examples 17-21 optionally include displaying the annotated rendered representation on a display in location B, wherein the annotation input is superimposed on the display of location A displayed in location B.

In Example 23, the subject matter of Example 22 optionally includes wherein, when a viewing perspective of the location A changes in location B, the annotation input remains superimposed on the display of location A displayed in location B.

In Example 24, the subject matter of any one or more of Examples 22-23 optionally include wherein when a viewing perspective of the location A changes in location A, the annotation input remains superimposed on the display of location A displayed in location B.

In Example 25, the subject matter of any one or more of Examples 22-24 optionally include sending the annotated 3-D model to the image capture device, wherein the image capture device is configured to superimpose the annotation input on a display of location A.

In Example 26, the subject matter of Example 25 optionally includes wherein, when the viewing perspective of the location A changes in location B, the annotation input remains superimposed on the display of location A displayed in location B.

In Example 27, the subject matter of any one or more of Examples 4-26 optionally include receiving a image capture device control input in location B; generating a rendered adjusted perspective representation of the location A based on the image capture device control input, the 3-D model, the plurality of images, wherein the rendered adjusted perspective representation is different from the live representation; and displaying the rendered adjusted perspective representation on the display in location B.

In Example 28, the subject matter of any one or more of Examples 4-27 optionally include receiving an annotation input, wherein generating the rendered adjusted perspective representation is further based on the annotation input.

In Example 29, the subject matter of any one or more of Examples 4-28 optionally include receiving a plurality of data from external sources, wherein generating the rendered adjusted perspective representation is further based on the plurality of data from external sources.

In Example 30, the subject matter of any one or more of Examples 27-29 optionally include wherein receiving the image capture device control input includes receiving a pan input, a zoom input, or an orbit input.

In Example 31, the subject matter of any one or more of Examples 13-30 optionally include wherein the zoom input is implemented as a combination of a forward virtual camera position movement, a backward virtual camera position movement, or a change in a virtual camera field of view.

In Example 32, the subject matter of any one or more of Examples 13-31 optionally include selecting a target perspective from a set of acceptable target perspectives in response to receiving the image capture device control input.

In Example 33, the subject matter of Example 32 optionally includes displaying, during receiving of the image capture device control input, a visualization of a tentative target perspective to be assumed given a current image capture device control input.

In Example 34, the subject matter of Example 33 optionally includes wherein the displaying the visualization includes a rendering of the location A from the tentative target perspective.

In Example 35, the subject matter of Example 34 optionally includes wherein the visualization is an abstract graphical element indicating an optical center of the tentative target perspective.

In Example 36, the subject matter of any one or more of Examples 27-35 optionally include wherein generating the rendered adjusted perspective representation includes generating at least one seamless transition between a plurality of perspectives.

In Example 37, the subject matter of Example 36 optionally includes wherein the at least one seamless transition includes a transition between the rendered adjusted perspective representation and the live representation.

In Example 38, the subject matter of Example 37 optionally includes wherein generating at least one seamless transition includes: applying a proxy geometry in place of unavailable geometric information; and blurring of select textures to soften visual artifacts due to missing geometric information.

Example 39 is a non-transitory computer readable medium, with instructions stored thereon, which when executed by the at least one processor cause a computing device to perform data processing activities of any one of the methods of Examples 1-38.

Example 40 is an apparatus comprising means for performing any of the methods of Examples 1-38.

Example 41 is a system for scene collaboration, the system comprising: a communication component to receive a plurality of images of a location A from an image capture device located in location A; a localization component to associate the plurality of images with a plurality of localization information; a collaboration component configured to receive a collaboration input in location B and associate the collaboration input with the plurality of localization information; wherein the communication component is further configured to send the collaboration input and the plurality of localization information to the image capture device.

In Example 42, the subject matter of Example 41 optionally includes a rendering component to generate a location A representation based on the plurality of images.

In Example 43, the subject matter of Example 42 optionally includes a display component to display the location A representation to a user in location B.

In Example 44, the subject matter of any one or more of Examples 41-43 optionally include wherein the communication component is further configured to receive the plurality of localization information from the image capture device.

In Example 45, the subject matter of any one or more of Examples 41-44 optionally include wherein the localization component is further configured to generate a localization data set for each of the plurality of images based on the plurality of images.

In Example 46, the subject matter of any one or more of Examples 42-45 optionally include wherein the rendering component is further configured to generate the location A representation based on a three-dimensional (3-D) model.

In Example 47, the subject matter of Example 46 optionally includes wherein the rendering component is further configured to generate the 3-D model using the plurality of images and the plurality of localization information.

In Example 48, the subject matter of any one or more of Examples 46-47 optionally include wherein the communication component is further configured to receive the 3-D model.

In Example 49, the subject matter of any one or more of Examples 41-48 optionally include wherein the localization component includes a plurality of physical computers, the plurality of physical computers configured to reduce a localization information latency and configured to reduce a latency-uncritical task load.

In Example 50, the subject matter of any one or more of Examples 41-49 optionally include wherein: the localization information includes an image capture device location and an image capture device orientation; and the localization information is generated using vision-based simultaneous localization and mapping (SLAM).

In Example 51, the subject matter of Example 50 optionally includes wherein the vision-based SLAM is monocular.

In Example 52, the subject matter of any one or more of Examples 41-51 optionally include wherein the rendering component generating the location A representation includes: freezing a viewpoint of the location A representation automatically during the receiving of the collaboration input; and resuming a live location A representation following the receiving of the collaboration input, wherein resuming the live location A representation includes displaying and tracking an updated viewpoint of the image capture device in physical location A.

In Example 53, the subject matter of any one or more of Examples 46-52 optionally include a 3-D modeler component to generate an annotated 3-D model based on the collaboration input, the 3-D model, and the plurality of images, wherein the annotated 3-D model includes a mapping of the collaboration input into the 3-D scene.

In Example 54, the subject matter of Example 53 optionally includes the 3-D modeler component further configured to integrate a plurality of data from external sources into the 3-D model.

In Example 55, the subject matter of Example 54 optionally includes the 3-D modeler component further configured to integrate an alignment input into the 3-D model, the alignment input including information to align the plurality of data from external sources with the 3-D model.

In Example 56, the subject matter of Example 55 optionally includes wherein integrating the alignment input into the 3-D model is based on computer vision based recognition or Global Positioning System (GPS) sensors.

In Example 57, the subject matter of any one or more of Examples 53-56 optionally include wherein: the collaboration input includes a two-dimensional (2-D) annotation input; and the 3-D modeler component is further configured to generate the annotated 3-D model based on a mapping from the collaboration input into the 3-D space, the mapping including information about an intended 3-D shape and a location of the collaboration input.

In Example 58, the subject matter of any one or more of Examples 53-57 optionally include wherein the rendering component is further configured to generate an annotated rendered representation in location B based on the annotated 3-D model.

In Example 59, the subject matter of Example 58 optionally includes wherein the annotated rendered representation of the collaboration input includes a visualization of the direction of the collaboration input.

In Example 60, the subject matter of Example 59 optionally includes wherein the visualization includes a flow animation.

In Example 61, the subject matter of any one or more of Examples 58-60 optionally include wherein the annotated rendered representation of the collaboration input is adapted in size based on an observer viewpoint proximity.

In Example 62, the subject matter of Example 61 optionally includes wherein the adaption in size is non-linear with respect to the observer viewpoint proximity.

In Example 63, the subject matter of any one or more of Examples 58-62 optionally include wherein the rendering component generating the annotated rendered representation includes superimposing the collaboration input on an object within location A.

In Example 64, the subject matter of Example 63 optionally includes wherein, when a viewing perspective of the location A changes in location B, the collaboration input remains superimposed on the object within the location A.

In Example 65, the subject matter of any one or more of Examples 63-64 optionally include wherein when a viewing perspective of the location A changes in location B, the collaboration input remains superimposed on the object within the location A.

In Example 66, the subject matter of any one or more of Examples 63-65 optionally include sending the annotated 3-D model to the image capture device, wherein the image capture device is configured to superimpose the collaboration input on a display in location B of the object within the location A.

In Example 67, the subject matter of Example 66 optionally includes wherein, when the viewing perspective of the location A changes in location B, the collaboration input remains superimposed on the object within the location A.

In Example 68, the subject matter of any one or more of Examples 46-67 optionally include a image capture device control component to receive a image capture device control input in location B; wherein the rendering component is further configured to generate a rendered adjusted perspective representation of the location A based on the image capture device control input, the 3-D model, the plurality of images, and the collaboration input; wherein the rendered adjusted perspective representation is different from the live representation.

In Example 69, the subject matter of Example 68 optionally includes wherein: the communication component is further configured to receive a plurality of data from external sources; and the rendering component is further configured to generate the rendered adjusted perspective representation is further based on the plurality of data from external sources.

In Example 70, the subject matter of Example 69 optionally includes wherein the plurality of data from external sources includes information about at least a first object of interest within the location A.

In Example 71, the subject matter of any one or more of Examples 68-70 optionally include wherein the image capture device control component is further configured to receive at least one of a pan input, a zoom input, and an orbit input.

In Example 72, the subject matter of any one or more of Examples 54-71 optionally include wherein the zoom input includes at least one of a forward virtual camera position movement, a backward virtual camera position movement, and a change in a virtual camera field of view.

In Example 73, the subject matter of any one or more of Examples 54-72 optionally include wherein the rendering component is further configured to select a target perspective from a set of acceptable target perspectives in response to receiving the image capture device control input.

In Example 74, the subject matter of Example 73 optionally includes wherein the rendering component is further configured to generate, during receiving of the image capture device control input, a visualization of a tentative target perspective to be assumed based on a current image capture device control input.

In Example 75, the subject matter of Example 74 optionally includes wherein the visualization includes a rendering of the location A from the tentative target perspective.

In Example 76, the subject matter of Example 75 optionally includes wherein the visualization includes an abstract graphical element indicating an optical center of the tentative target perspective.

In Example 77, the subject matter of any one or more of Examples 68-76 optionally include wherein the rendering component is further configured to generate at least one seamless transition between a plurality of perspectives.

In Example 78, the subject matter of Example 77 optionally includes wherein the at least one seamless transition includes a transition between the rendered adjusted perspective representation and the live representation.

In Example 79, the subject matter of Example 78 optionally includes wherein the rendering component generating the at least one seamless transition includes: applying a proxy geometry in place of unavailable geometric information; and blurring of select textures to soften visual artifacts due to missing geometric information.

Example 80 is a system for scene collaboration, the system comprising: an image capture device to capture a plurality of images of a location A; a localization component to generate a plurality of localization information from the plurality of images, the plurality of localization information providing a localization data set for each of the plurality of images; a communication component to send the plurality of images and the plurality of the localization information to a device in location B and to receive collaboration information from the device in location B, the collaboration information based on the localization information and based on a collaboration input; and a rendering component to receive the plurality of images of location A, the plurality of localization information, and the collaboration input, and to generate an annotated image for viewing by a user in location A.

In Example 81, the subject matter of Example 80 optionally includes wherein: the plurality of images of a location A includes a first image of an object; and the collaboration input includes an annotation on the first image of the object.

In Example 82, the subject matter of Example 81 optionally includes wherein the annotated image includes the annotation superimposed on the object within the first image.

In Example 83, the subject matter of any one or more of Examples 81-82 optionally include wherein: the plurality of images of a location A includes a second image of the object, the second image being different from the first image; and the annotated image includes the annotation superimposed on the object within the second image.

In Example 84, the subject matter of Example 83 optionally includes wherein the rendering component is further configured to generate a representation of the location A based on a three-dimensional (3-D) model and the plurality of images.

In Example 85, the subject matter of Example 84 optionally includes wherein the rendering component is further configured to generate the 3-D model using the plurality of images and the plurality of localization information.

In Example 86, the subject matter of any one or more of Examples 80-85 optionally include wherein the communication component is further configured to receive the 3-D model.

In Example 87, the subject matter of any one or more of Examples 80-86 optionally include wherein the communication component is further configured to send the plurality of images and the plurality of the localization information to a plurality of computing devices and to receive the collaboration information from the plurality of computing devices, the plurality of computing devices configured to reduce a localization information latency and configured to reduce a latency-uncritical task load.

In Example 88, the subject matter of any one or more of Examples 80-87 optionally include wherein the plurality of localization information includes: a plurality of locations, each location associated with each of the plurality of images; and a plurality of orientations, each orientation associated with each of the plurality of images.

In Example 89, the subject matter of any one or more of Examples 80-88 optionally include wherein the localization information is generated using vision-based simultaneous localization and mapping (SLAM).

In Example 90, the subject matter of Example 89 optionally includes wherein the vision-based SLAM includes a monocular vision-based SLAM.

In Example 91, the subject matter of any one or more of Examples 85-90 optionally include wherein the rendering component is further configured to generate the 3-D model based on a plurality of external source data.

In Example 92, the subject matter of Example 91 optionally includes wherein the rendering component is further configured to integrate an alignment input into the 3-D model, the alignment input including information to align the 3-D model with the plurality of external source data.

In Example 93, the subject matter of Example 92 optionally includes wherein integrating the alignment input into the 3-D model is based on computer vision based recognition or Global Positioning System (GPS) sensors.

In Example 94, the subject matter of any one or more of Examples 85-93 optionally include wherein: the annotation includes a two-dimensional (2-D) annotation input; and the generated 3-D model includes generating an annotated 3-D model based on a mapping from the annotation into a 3-D space, the mapping including information about an intended 3-D shape and a 3-D location of the annotation.

In Example 95, the subject matter of Example 94 optionally includes wherein the annotated 3-D model includes a visualization of an annotation input direction.

In Example 96, the subject matter of Example 95 optionally includes wherein the visualization includes a flow animation.

In Example 97, the subject matter of any one or more of Examples 94-96 optionally include wherein the annotated 3-D model is adapted in size based on an observer viewpoint proximity.

In Example 98, the subject matter of Example 97 optionally includes wherein the adaption in size is non-linear with respect to the observer viewpoint proximity.

In Example 99, the subject matter of any one or more of Examples 94-98 optionally include wherein the rendering component generating the annotated image is based on a combination of the annotated 3-D model and second image of the object.

In Example 100, the subject matter of Example 99 optionally includes wherein, when a viewing perspective of the image capture device changes, the annotation remains superimposed on the object.

In Example 101, the subject matter of any one or more of Examples 84-100 optionally include an image capture device control input device in location A to receive an image capture device control input; wherein the rendering component is further configured to generate a rendered adjusted perspective representation based on the image capture device control input, the 3-D model, and the plurality of images, wherein the rendered adjusted perspective representation is different from a live representation of the scene in location A.

In Example 102, the subject matter of Example 101 optionally includes wherein the image capture device control input includes at least one of a pan input, a zoom input, or an orbit input.

In Example 103, the subject matter of any one or more of Examples 84-102 optionally include an annotation input device in location A to receive a annotation input, wherein generating the annotated image is further based on the annotation input.

In Example 104, the subject matter of any one or more of Examples 101-103 optionally include wherein the image capture device control input includes at least one of a forward virtual camera position movement, a backward virtual camera position movement, and a change in a virtual camera field of view.

In Example 105, the subject matter of any one or more of Examples 103-104 optionally include wherein the rendering component is further configured to select a target perspective from a set of acceptable target perspectives in response to receiving the image capture device control input.

In Example 106, the subject matter of Example 105 optionally includes wherein the rendering component is further configured to generate a tentative target perspective image during receiving of the image capture device control input, the tentative target perspective image including a tentative target perspective to be assumed given a current image capture device control input.

In Example 107, the subject matter of Example 106 optionally includes wherein generating the tentative target perspective image includes a rendering of the 3-D model from the tentative target perspective.

In Example 108, the subject matter of Example 107 optionally includes wherein the tentative target perspective image includes an abstract graphical element indicating an optical center of the tentative target perspective.

In Example 109, the subject matter of any one or more of Examples 101-108 optionally include wherein the rendering component is further configured to generate at least one seamless transition between a plurality of perspectives.

In Example 110, the subject matter of Example 109 optionally includes wherein the at least one seamless transition includes a transition between the rendered adjusted perspective representation and the live representation of the scene in location A.

In Example 111, the subject matter of Example 110 optionally includes wherein the rendering component is further configured to: apply a proxy geometry in place of unavailable geometric information; and blur of select textures to soften visual artifacts due to missing geometric information.

Each of these non-limiting examples can stand on its own, or can be combined in various permutations or combinations with one or more of the other examples.

Conventional terms in the fields of computer vision have been used herein. The terms are known in the art and are provided only as a non-limiting example for convenience purposes. Accordingly, the interpretation of the corresponding terms in the claims, unless stated otherwise, is not limited to any particular definition. Thus, the terms used in the claims should be given their broadest reasonable interpretation.

Although specific embodiments have been illustrated and described herein, it will be appreciated by those of ordinary skill in the art that any arrangement that is calculated to achieve the same purpose may be substituted for the specific embodiments shown. Many adaptations will be apparent to those of ordinary skill in the art. Accordingly, this application is intended to cover any adaptations or variations.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer-readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read-only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. §1.72(b), to allow the reader to quickly ascertain the nature of the technical disclosure and is submitted with the understanding that it will not be used to interpret or limit the scope or meaning of the claims. In addition, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the embodiments should be determined with reference to the appended claims, along with the full scope of equivalents to which such claims are entitled.

What is claimed is:

1. A method for communication, the method comprising:
receiving a plurality of images of a location A from an image capture device in location A;
associating a plurality of localization information with the plurality of images, the plurality of localization information providing a localization data set for each of the plurality of images; and
sending collaboration information to a device in location B, the collaboration information based on the localization information and based on a collaboration input.

2. The method of claim 1, further including generating a location A representation based on a three-dimensional (3-D) model and the plurality of images.

3. The method of claim 1, wherein:
the localization information includes an image capture device location and an image capture device orientation; and
the localization information is generated using vision-based simultaneous localization and mapping (SLAM).

4. The method of claim 2, further including receiving an annotation input.

5. The method of claim 4, further including:
freezing a viewpoint of the location A representation automatically during the receiving of the annotation input; and
resuming a live location A representation following the receiving of the annotation input, wherein resuming the live location A representation includes displaying and tracking an updated viewpoint of the image capture device in physical location A, wherein resuming the live location A representation includes displaying and tracking an updated viewpoint of the image capture device in physical location A.

6. The method of claim 4, further including generating an annotated 3-D model based on the annotation input, the 3-D model, and the plurality of images, the annotated 3-D model including a mapping of the annotation input into the 3-D scene.

7. The method of claim 6, further including generating an annotated rendered representation in location B based on the annotated 3-D model.

8. The method of claim 7, further including displaying the annotated rendered representation on a display in location B, wherein the annotation input is superimposed on the display of location A displayed in location B.

9. The method of claim 8, further including sending the annotated 3-D model to the image capture device, wherein the image capture device is configured to superimpose the annotation input on a display of location A.

10. The method of claim 2, further including:
receiving a image capture device control input in location B;
generating a rendered adjusted perspective representation of the location A based on the image capture device control input, the 3-D model, the plurality of images, wherein the rendered adjusted perspective representation is different from the live representation; and
displaying the rendered adjusted perspective representation on the display in location B.

11. A system for scene collaboration, the system comprising:
a communication component to receive a plurality of images of a location A from an image capture device located in location A;
a localization component to associate the plurality of images with a plurality of localization information;
a collaboration component configured to receive a collaboration input in location B and associate the collaboration input with the plurality of localization information;
wherein the communication component is further configured to send the collaboration input and the plurality of localization information to the image capture device.

12. The system of claim 11, further including a rendering component to generate a location A representation based on the plurality of images.

13. The system of claim 12, wherein the rendering component is further configured to generate the location A representation based on a three-dimensional (3-D) model.

14. The system of claim 13, wherein the rendering component is further configured to generate the 3-D model using the plurality of images and the plurality of localization information.

15. The system of claim 11, wherein:
the localization information includes an image capture device location and an image capture device orientation; and
the localization information is generated using vision-based simultaneous localization and mapping (SLAM).

16. A system for scene collaboration, the system comprising:
an image capture device to capture a plurality of images of a location A;
a localization component to generate a plurality of localization information from the plurality of images, the plurality of localization information providing a localization data set for each of the plurality of images;
a communication component to send the plurality of images and the plurality of the localization information to a device in location B and to receive collaboration information from the device in location B, the collaboration information based on the localization information and based on a collaboration input; and
a rendering component to receive the plurality of images of location A, the plurality of localization information, and the collaboration input, and to generate an annotated image for viewing by a user in location A.

17. The system of claim 16, wherein:
the plurality of images of a location A includes a first image of an object; and
the collaboration input includes an annotation on the first image of the object.

18. The system of claim 17, wherein the annotated image includes the annotation superimposed on the object within the first image.

19. The system of claim 17, wherein:
the plurality of images of a location A includes a second image of the object, the second image being different from the first image; and
the annotated image includes the annotation superimposed on the object within the second image.

20. The system of claim 19, wherein the rendering component is further configured to generate a representation of the location A based on a three-dimensional (3-D) model and the plurality of images.
